(19) United States
(12) Patent Application Publication
(10) Pub. No.: US 2014/0258117 A1
(43) Pub. Date: Sep. 11, 2014

(54) METHODS AND SYSTEMS FOR HANDLING CURRENCY

(71) Applicant: Daniel Holland, Verona, NJ (US)

(72) Inventor: Daniel Holland, Verona, NJ (US)

(21) Appl. No.: 14/160,790

(22) Filed: Jan. 22, 2014

Related U.S. Application Data
(63) Continuation-in-part of application No. 13/429,751, filed on Mar. 26, 2012, now Pat. No. 8,676,700.

(51) Int. Cl. G06Q 20/10

(52) U.S. Cl. CPC G06Q 20/108
USPC 705/42

(57) ABSTRACT

A bulk deposit can be made at a financial institution based on dealings between a remitter and the remitter's agent. Information concerning transactions between the agent and the agent's customers, may be transferred by the agent to the remitter and, in turn, from the remitter to a service provider that is distinct from the agent, the remitter, and the remitter's bank. The service provider can generate a deposit slip and store in a database, information about the slip. This deposit slip may be marked with transaction amounts for the agent's customers, the bulk cash to be deposited; and a summary of any discrepancy between the two. The provider may make available to the financial institution at least some of the transaction information including its correlation to the deposit slip, and detail greater than that produced on the deposit slip.

### CROSS-REFERENCE TO RELATED APPLICATIONS

This application is a continuation-in-part of U.S. patent application Ser. No. 13/429,751, filed Mar. 26, 2012, entitled “Methods and Systems for Handling Currency,” the disclosure of which is incorporated by reference herein in its entirety.

### BACKGROUND

1. Field of the Invention

Embodiments of the present invention are generally related to bulk cash, and in particular, to the banking systems, money remitters, and the tracking of bulk cash to its origin. In addition, the present invention relates to deposit slips. Moreover, the present invention relates to processes for sharing information and methods for tracking a remitter's activity.

2. Description of the Related Art

A wire transfer is a system for sending money from one location to another via an electronic format. Wire transfers have existed for over 140 years as a way to safely and securely send money. It can be considered one of the oldest industries in the U.S. It began in 1871 when Western Union, one of the original 11 stocks included in the first Dow Jones Average, introduced it as a service. Western Union then began providing service to Europe, North Africa, North and South America, Australia and Asia in 1896.

A Money Remitter is a business entity that operates through a network of agents that are collecting cash on behalf of their customers with the goal of sending it to the customer's beneficiary. The collection of cash from the customer is part of what is herein referred to as a “transaction”. The Remitter's agent takes each individual's remittance and combines it together with the other individuals' remittances to make one cash deposit in the bank. Grouping multiple transactions into one deposit creates cost efficiency. This accumulating of multiple cash transactions into one amount is referred to as “bulk cash.” A Remitter's agent creates bulk cash and periodically to brings it to a bank.

The money remitter industry has grown steadily, with the last 20 years bringing double digit growth year over year. However, the events of Sep. 11, 2001 have changed the way regulators look at foreign money transfers.

In the past few years, governments worldwide have established several new policies to prevent improper use of financial institutions by criminals and terrorists. A number of businesses, such as money services businesses (MSB), travel agencies, jewelry stores, pawnshops, etc., have to comply with regulatory rules and requirements for the purpose of preventing fraud, money laundering, and terrorist financing.

According to the USA PATRIOT Act, financial institutions and money service businesses must authenticate the identity of an individual before executing any transaction for that individual. Under the PATRIOT ACT, banks have had a difficult time complying with the new laws imposed upon them. Banks have gone to great lengths to institute policies and programs that may ensure compliance with the law.

The implementation of the PATRIOT ACT placed far greater scrutiny on the banking industry's requirements to implement effective BSA (Bank Secrecy Act) programs and turned compliance into an industry all its own. For the last decade, banks have worked diligently to increase their compliance departments' ability to keep up with fraudulent and criminal acts that have been made possible by new technologies.

The relevant laws and regulations include a Know Your Customer (KYC) requirement. In addition, as part of a Money Service Business (MSB) KYC policy MSB's are also expected to effectively Know Your Customer's Customer (KYCC). However, it is extremely difficult to not only know your customer's activity, but to know your customer's customers activity when it involves cash and only limited information is available.

U.S. Bank regulators such as Federal Reserve Bank (FRB), Federal Deposit Insurance Corporation (FDIC), Office of Comptroller of Currency (OCC), and Office of Thrift Supervision (OTS) issued a joint statement, confirming that a financial institution has to file a Suspicious Activity Report (SAR) if the financial institution knows that its customer has violated any law.

Also, financial institutions and money service businesses must comply with the requirements of the Office of Foreign Assets Control (OFAC), prohibiting business activities with any entity on the blacklist periodically published by the OFAC. Moreover, under the Bank Secrecy Act, financial institutions and money service businesses are required to file a Currency Transaction Report (CTR) if transactions by a customer exceed $10,000 in cash on the same day. They must also file a Suspicious Activity Report (SAR) for any suspicious activity, including structured activities that attempt to avoid the filing of a CTR.

The increased importance of a bank's compliance department in implementing BSA laws and effective Know Your Customer policies has made it increasingly difficult for banks and Money Service Business's (MSG's) to work together. The result has been a decade long string of account closings and lost business relationships.

Special problems have arisen with a specific type of MSB referred to as Money Remitters. A money remitter, herein referred to as a remitter, is someone who specializes in wire transfers. When it comes to remitters, banks have found it easier to close the remitters' accounts rather than service them and risk financial and criminal penalties. Western Union is considered the largest money remitter in the world and even it has lost accounts with certain banks.

Remitters typically have in-house compliance programs and external reviews of these programs. Banks also have in-house compliance programs and external reviews. However, these two operations are uncoordinated.

It is common for remitters and their agents to collect cash from multiple customers and make one bulk deposit into a financial institution. The remitter then executes a wire through a financial institution to a correspondent remitter who receives one lump sum and then distributes cash to the respective customers' beneficiaries (see FIG. 1).

The financial institution receiving the remitter's bulk deposit and performing the wire does not have access to the details of the remitter's individual customers and cannot identify which customers are sending money, how much they are sending and who is receiving the funds. This makes it difficult for banks to comply with various BSA, Anti-Money Laundering (AML) laws, and the PATRIOT ACT.

Remitters also make their cash deposits on a standard bank deposit slip. A standard deposit slip does not make it possible to identify the source of the cash. In addition, the agent of the remitter typically does not deposit exact amounts creating either a receivable or payable making it further difficult for the bank to understand the activity of the remitter.

Cash—For purposes of this application, cash refers to the physical currency printed on banknotes as well as coins that may be exchanged for goods or services. More specifically, in reference to this patent application, cash refers to any instrument that may be deposited in a traditional commercial bank account for credit in a customer's account. Bulk Cash—refers to a large quantity of paper money or coins. More specifically, in reference to this patent application, bulk cash refers to the grouping of multiple cash transactions into one amount for a bulk deposit into a financial institution. These deposits of cash may represent one or more transactions on behalf of a third-party and the details of the third-party are often considered to be unknown to the financial institution in which the bulk cash is being deposited. Deposit Slip—A small written form that is used to deposit funds into a financial institution.

A deposit slip typically indicates the date, the name of the depositor, the depositor's account number and the amounts of checks, cash and coin being deposited. In a traditional deposit slip, the lines that state the words “cash”, “coins” and “checks” are there to signify the type of currency being deposited into the account. It is not a reference to the origins of the currency. Cash being deposited into a bank account can be for many reasons including income earned from sales in the ordinary course of business, refunds, customer deposits, investments into a company, additional amounts paid as capital from the owner(s), escrow, etc.

### SUMMARY

In accordance with exemplary embodiments of the present invention, there is provided a method performed by a provider for facilitating a bulk deposit to a financial institution based on dealings between a remitter and an agent of the remitter. The method may include downloading from the remitter to the provider, transaction information concerning one or more transactions between the agent and one or more customers of the agent. The method may further comprise storing, by the provider, information about a deposit slip having a marking signifying said one or more customers. In some embodiments, the deposit slip may be suitable for delivery to the financial institution together with bulk cash corresponding to the transaction information. The method may also comprise making available from the provider to the financial institution at least some of the transaction information including (a) its correlation to the deposit slip, and (b) detail greater than that produced on the deposit slip.

In accordance with another aspect of embodiments of the present invention, a method is provided for accepting bulk cash at a financial institution based on transaction information stored by a provider concerning one or more transactions between an agent of a remitter and one or more customers of the agent. The method may comprise reviewing at the financial institution a deposit slip having a marking signifying the one or more customers, together with bulk cash corresponding to the transaction information. Another step may be downloading at the financial institution from the provider at least some of the transaction information. The step of downloading may include downloading information comprising (a) a correlation to the deposit slip, and (b) detail greater than that produced on the deposit slip. The method may also comprise analyzing the transaction information at the financial institution to obtain information about the deposit slip that was not originally produced upon the deposit slip.

In accordance with exemplary embodiments, a system is provided for facilitating delivery of information about a deposit to a financial institution based on dealings between a remitter and an agent of the remitter. The system may include a primary database operable to store transaction information concerning one or more transactions between the agent and one or more customers of the agent. The system may also include a generator for producing a deposit slip adapted for delivery to the financial institution and having markings signifying (a) the one or more customers, and (b) bulk cash corresponding to the transaction information. Also included is an interface operable to provide to the financial institution from the primary database at least a predetermined portion of the transaction information including (a) its correlation to the deposit slip, and (b) detail greater than that produced on the deposit slip.

In accordance with exemplary embodiments, a deposit slip is provided for depositing bulk cash at a financial institution in connection with one or more customers of an agent. The deposit slip may be marked with: (a) a listing of transaction amount for each of said one or more customers of the agent; (b) an amount of bulk cash to be delivered to the financial institution with the deposit slip; and (c) a summary of any discrepancy between the listing of transaction amount and bulk cash being delivered to the financial institution.

Methods and systems in accordance with embodiments of the present invention may be used to track bulk cash to its original sources. The system may create a process, implemented by a distinct provider, for connecting a remitter's system to a bank's system in order to provide detailed information about the source of cash a remitter is depositing into a financial institution. The system may produce a unique deposit slip that is specifically adapted to the MSB industry. Furthermore, the system creates a process for tracking and understanding the receivable/payable balance of a remitter. In the process, the system may organize the data into a meaningful database for assistance in complying with applicable BSA/AML laws and regulations including the ability to know your customer's customer.

Methods and systems of the foregoing type may permit scoring the remitter's activity based on the amount of information provided. The system may allow the remitter to upload to a distinct provider, copies of CTR forms required by law for every cash transaction over $10,000. The system may also allow for uploading copies of photo ID, which is required for transactions over $3,000. The system may allow for data entry for fields such as, but not limited to, name, address, SSN, tax ID number, passport number, bank account number, telephone number and beneficiary name, address and telephone number. Based on the amount of information provided, the system may score the remitter to provide a risk level for the financial institution to use in determining the quality of the clients transactions for AML/BSA compliance risk.

The foregoing may allow effective Know Your Customer's Customer (KYCC) policy. The system may provide for a user friendly, easily accessible, real time database of the customer activity of the agents of the remitter. This effectively creates the ability for the financial institution to know your customer's customer. By creating a system for generating specific queries about a bulk cash deposit made at a financial institution, the financial institution has the ability to generate knowledge about its customer's customer. This gives the financial institution valuable insight and allows it to comply with the stringent BSA/AML laws of both federal and state agencies.

By employing methods and systems of the foregoing type, an improved technique is achieved for allowing a bulk deposit to be made at a financial institution. The term bulk deposit is intended to refer to multiple cash transactions that are bundled into one transaction and delivered to a financial institution by one individual or entity on behalf of several ostensibly unidentified individuals or entities.

In one embodiment a remitter may work with a network of agents, for example, a network of stores or other local outlets that deal directly with customers wishing to send money to a beneficiary. In this situation a customer (the sender) may bring cash or other monetary valuables to an agent who may then access a network to transfer the appropriate information to the remitter, either electronically or by conventional means (telephone, paper, and the like). This transaction information may include, but is not limited to, the amount to be transferred, the customer's name, address and date of birth, as well as, but not limited to, the beneficiary's name and address. The transaction information may also include details on the type of identification provided by the customer.

The present, improved technique allows for a financial institution to implement an effective Know Your Customer (KYC) policy. In order to truly know one's customer, one must know the customer's customer. The process of capturing the information about the bulk deposit takes anonymous information and gives it identity.

A system in accordance with exemplary embodiments may create a unique deposit slip for the remitter industry, and provide for a process of bridging between the remitter's system and the bank's system, to create a platform for generating reports that are useful to the financial institution and gives the financial institution the ability to access information about a cash transaction that was previously considered anonymous.

Compliance has become an industry all its own. In this new industry of compliance, financial institutions do not have a system for tracking/determining where cash is coming from when being deposited as a “bulk deposit.” This application discloses a unique deposit slip that offers the ability to track the cash in detail and have the bank's customers define where it came from. This assists the financial institution in determining its liability and risks in dealing with certain money remitter clients.

The unique sender ID on the deposit slip may give a bank the ability to determine the specific origins of the cash and its specific purpose. Authorization Number—this feature may allow for an authorization process, a process where on a daily basis a person (e.g., the remitter's agent) to get permission to come to the bank and deposit into an account belonging to somebody else (the money remitter).

Over/Under—The traditional system only records exactly what was deposited into the bank. The disclosed deposit slip may provide the ability to track a variation between what the agent's customer's activity was and what was actually deposited into the account.

In exemplary embodiments, software running at the remitter's office may detect whether the transaction amount exceeds $3,000.00. If so, the agent may be automatically asked to provide additional details about the identification presented by the customer. These details may be uploaded to the provider's system and the provider's system may have the ability to make it available for review by the financial institution's system.

If the transaction amount exceeds $10,000.00 and the agent has not already done so, the agent may be automatically be asked to upload an image of the photo ID presented by the customer. In addition, a blank form may appear on the remitter's monitor. By completing this form, the remitter may have effectively prepared a Currency Transfer Report (CTR) that can be sent electronically or can be printed and mailed to the appropriate authorities. This form can be uploaded to the provider's system and the provider's system may have the ability to make it available for review by the financial institution's system.

In any event, the proposed transaction may be presented on the remitter's monitor for final review. At this time, the customer and the beneficiary can be automatically checked against an OFAC blacklist. Also, to comply with anti-money laundering laws, the remitter can look for structuring schemes, smurphing, etc. If in the end the agent is trusted and the transaction(s) otherwise seems appropriate, the remitter may approve this transaction(s) with the agent and request a deposit slip through the provider's system. An approval screen may be generated for the remitter to acknowledge that the transactions have been reviewed by their compliance system and the transactions meet all appropriate standards and requirements and the transactions are OK to be deposited for transmission to sender's beneficiary.

Eventually, cash collected by the agent from one or more customers may need to be deposited at the remitter's bank or other financial institution. With the disclosed system the remitter may complete a proposed deposit form to send to the agent for depositing currency with the remitter's bank. This form may have the appearance of an ordinary deposit slip with one or more lines, each line having an identification code for a customer and the corresponding transaction amount. This proposed deposit slip may normally be restricted to a single agent and therefore may not list customers unrelated to that agent.

The proposed deposit slip may total all of the transaction amounts. In practice, however, an agent does not always bring in that precise amount. There is a certain amount of rounding and the agent may bring in more or less than the transaction total. Accordingly, the proposed deposit slip may indicate the actual amount of currency to be deposited. In addition, the difference between the actual deposit and the transaction total may be listed on the deposit slip as a discrepancy.

The proposed deposit slip may simultaneously appear on the remitter's monitor for approval. The deposit of an excessive amount of cash may suggest money laundering through the agent. On the other hand, a greatly insufficient cash deposit may suggest misappropriation by the agent. The disclosed system may also give the remitter an opportunity to review the transaction history for this agent. The remitter can make now a judgment as to whether to approve the proposed deposit.

If the deposit is approved, a deposit slip may be printed by the remitter to be delivered to the agent by hand or delivered via email or fax. Information relating to the associated transaction held by the remitter may be made available to the remitter's bank. It may be understood that the remitter may have been accumulating several transactions from this one agent and therefore multiple transactions may be uploaded simultaneously in connection with a single deposit.

When the agent arrives at the remitter's bank with the deposit slip and cash (currency), the bank clerk may verify the deposit slip by accessing the provider's program. In particular, the financial institution may be asked to enter the amount being deposited, which amount has just been physically verified by the financial institution. If the deposit slip is verified, the bank clerk may consider the deposit slip as ordinary and may complete the deposit in the usual manner.

It may be appreciated that in some instances the agent may instead deliver cash to the remitter, who may then physically make the deposit on behalf of the agent using the appropriate deposit slip.

For paperless transactions the deposit slip may simply appear electronically on the monitor for all concerned parties, including the bank.

Once funds have been deposited with the bank, the remitter is now free to instruct the bank to execute a wire transfer to a correspondent bank, either another domestic bank or a foreign bank. The correspondent bank may then credit the account of a remitter's transfer agent that is in a position to facilitate the overall transaction. Often, this correspondent transfer agent may, upon request, provide authorization when a store or outlet is approached by a beneficiary requesting the funds that originated with the customer.

An advantage with the foregoing is that the remitter's bank has comprehensive access to the relevant transaction information. In the past, during regulatory inspection, the remitter's bank would only have a deposit slip for a large amount of cash and would only know the identity of the remitter. Now instead, the bank can examine and display the transaction information sent from the remitter, which is now stored in the provider's database. Therefore if governmental regulators want to make inquiries about large cash transactions, the bank can easily identify its remitter, the agents associated with the remitter, and the customers dealing with those agents. This information can be quite detailed and can include the names and addresses of customers and beneficiaries, information about the form of the customers' identification, images of the identification when appropriate, etc.

### BRIEF DESCRIPTION OF THE DRAWINGS

So the manner in which the above recited features of the present disclosure can be understood in detail, a more particular description of embodiments of the present disclosure, briefly summarized above, may be had by reference to embodiments, which are illustrated in the appended drawings. It is to be noted, however, the appended drawings illustrate only typical embodiments of embodiments encompassed within the scope of the present disclosure, and, therefore, are not to be considered limiting, for the present disclosure may admit to other equally effective embodiments, wherein:

FIG. 1 depicts a system-level network diagram of a system for handling currency in accordance with embodiments of the present invention;

FIG. 2 depicts a block diagram of a general computer system, which is capable of being used in connection with the system depicted in FIG. 1, in accordance with embodiments of the present invention;

FIG. 3 depicts a block diagram of a system for handling currency in accordance with embodiments of the present disclosure;

FIG. 4 depicts an exemplary client computer capable of being used with the system depicted in FIG. 1, in accordance with embodiments of the present invention;

FIG. 5 is a schematic diagram of a system implementing methods and apparatus in accordance with principles of the present invention;

FIG. 6 illustrates a continuation of the schematic diagram of a system for handling currency in accordance with embodiments of the present invention;

FIG. 7 illustrates a deposit slip associated with a system for handling currency in accordance with embodiments of the present invention;

FIG. 8 is a flowchart associated with a system for handling currency in accordance with embodiments of the present invention;

FIG. 9 is a screenshot displaying a remitter's daily deposits as stored on one of the databases associated with a system for handling currency in accordance with embodiments of the present invention;

FIG. 10 is a screenshot giving a breakdown of one of the daily deposits from FIG. 4, listing the total deposited for each agent for that day;

FIG. 11 is a screenshot listing the senders, receivers and amounts sent for one of the agents' deposits;

FIGS. 12 and 13 are screenshots giving the full details of senders and receivers for one of the agents;

FIG. 14 is a screenshot giving the details of senders sending over $3,000.00 but less than $10,000.00 for one of the deposit dates;

FIG. 15 is a screenshot giving the details of senders sending over $10,000.00 for one of the deposit dates;

FIG. 16 is a screenshot to be used by a remitter to select transactions for approval and for creation of a deposit slip;

FIG. 17 is a screen shot of an acknowledgement screen that a remitter must accept to generate the deposit slip; and

FIG. 18 is a screenshot used for identifying missing data that a remitter ought go back and add to the transaction information.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to bulk cash, and in particular, to the banking systems, money remitters, and the tracking of bulk cash to its origin. In addition, the present invention relates to deposit slips. Moreover, the present invention relates to processes for sharing information and methods for tracking a remitter's activity.

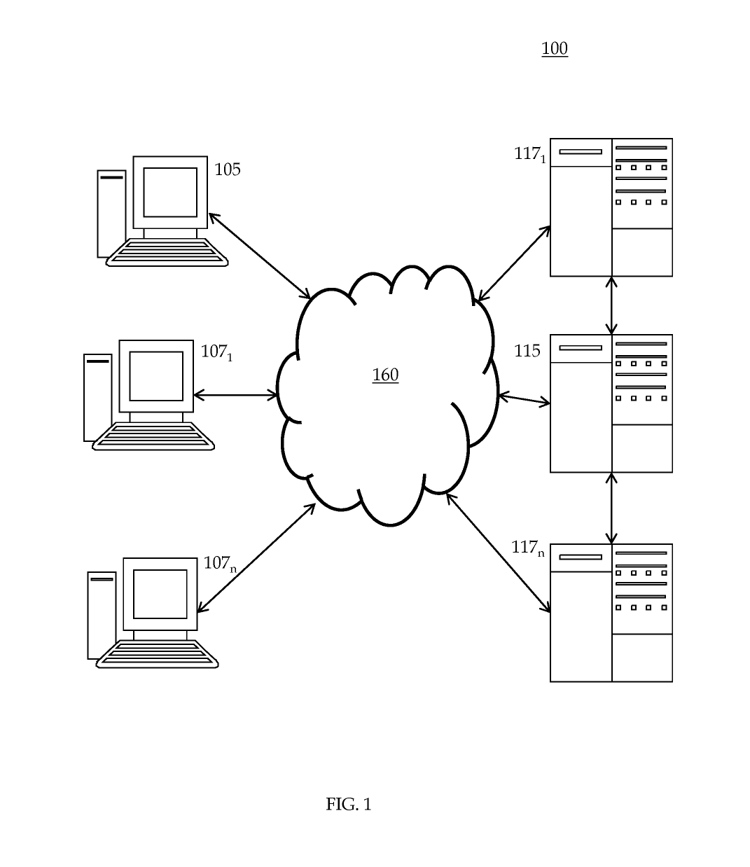

FIG. 1 depicts a system-level network diagram of a system 100 for handling currency in accordance with embodiments of the present invention. In exemplary embodiments, the system 100 may be adapted to capture, transmit, analyze, filter, review, and/or archive all information relating to bulk cash and associated transactions, providing a detailed, easy to access, electronic account of the specific flow of incoming and outgoing transactions. In accordance with embodiments of the present invention, information may be collected from multiple data sources and transmitted to a central repository where the data may be aggregated, filtered, and flagged for immediate review, or archived for future retrieval based on predetermined settings configured by an administrator.

Embodiments of the present invention may generally provide alerts and/or notifications of possible incidences of compliance liability, providing numerous benefits to customers, agents, remitters, banks, financial institutions, and/or the like.

In accordance with exemplary embodiments, the system 100 generally comprises at least a first client 105, generally in communication with a server 115 via a network 160. In some embodiments, the system 100 may comprise secondary clients 107₁ and 107ₙ. The clients may be in communication with the host server 115, generally through the network 160. As used herein, the terms “customer” and “customers” may refer to one or more individuals seeking to transfer cash to a recipient via an agent of a remitter, and/or the like. As used herein, the term “bank” may refer to any financial institution.

A system 100 in accordance with embodiments of the present invention may provide various benefits to customers, agents, remitters, banks, and/or the like. By way of example, a system 100 in accordance with the present invention may give banks insight and gather intelligence on day-to-day operations; identify the specific flow of incoming and outgoing transactions; gain access to detailed transaction data; and build a meaningful database of customers. Financial institutions face ever increasing challenges due to an unstable global economy and local financial hardships. One of the banks many challenges is compliance. Many banks are unable to maintain Licensed Money Transmitter (LMT) accounts due to the inability to properly monitor where cash is coming and going. In order to know the banks' customer, it must effectively know its customer's customer, and/or the like. Truly knowing and understanding a banks customer's customer may be facilitated by embodiments of the present invention. Embodiments of the present invention may comprise a system 100 adapted to break down bulk deposits into sender and receiver specific information, identify detailed sender and receiver information, provide a meaningful database of remitter activity, and automatically generate a details electronic deposit slip, and/or the like. By way of example a money transfer processes may flow from the customer to a store agent, from the store agent to an LMT, from the LMT to a domestic bank, from the domestic bank to a foreign bank, from the foreign bank to a corresponding transfer agent, from the corresponding transfer agent to a store agent, from the store agent to a receiver, or the like. As such, it is impossible to track the original sender under existing systems using existing information and deposit slips, and the like. An information breakdown often occurs between the LMT and the domestic bank, because the domestic bank has no access to the original sender's information. A system 100 in accordance with embodiments of the present invention solves this problem by providing detailed transaction information linking cash deposits to individual senders. A system 100 in accordance with embodiments of the present invention may include a deposit slip adapted to receive a sender ID associated with and identifying a sender, and a transaction amount associated with the sender ID.

In exemplary embodiments of the present invention, a system 100 may provide the ability to easily review details of specific LMT deposits with a breakdown of information, thus identifying every sender and receiver in the makeup of each transaction. A system 100 in accordance with exemplary embodiments of the present invention may be adapted to analyze an LMT's deposit data to identify multiple transaction patterns and flag and/or alert a user of suspicious activity; authenticate the origin of each deposit and sender's identification; verify that Currency Transition Reports are filed as required; verify that a sender is not on the OFAC list; and/or confirm that a copy of the proper ID was obtained if required by law, or the like. A system 100 in accordance with embodiments of the present invention may be adapted to allow a bank to view a listing of deposit amounts and drill down, for example, via a selectable link to the deposit details for a specific date or deposit. In some embodiments, the deposit details may comprise one or more of a date, an agent identification, an agent deposit amount, the amount the agent actually received from the customer, a deposit authorization and/or authorization identifier generated by the system 100, over/under identifying the amount over/or under the deposit is when compared to the amount the agent received, further deposit details, and a branch number, and/or the like. The system 100 may also be adapted to provide totals of each individual deposit for a particular day or for a particular bulk deposit. The further details selectable, sortable, filterable, and searchable by the bank provided by the system 100 may include an agent identifier, an agent deposit amount, an agent amount received, individual sender amounts for the agent amount received, sender names for each individual sender, and receiver names associated with each individual sender and sender amount, and/or the like. Further information that may be provided by the system may include a user identifier, a license number, an invoice number, a status identifier, an issued date, an issued time, an amount, a sender sysID, a sender name, a sender identifier, a sender id type, a sender date of birth, a sender address, a sender city, a sender state, a sender zip code a sender phone number, a sender citizenship, a receiver sysID, a receiver name, a receiver ID, a receiver address, a receiver city, a receiver state, a receiver country, a receiver phone, a receiver citizenship, a bank name, a bank branch, an account type, an account number, and/or the like.

Exemplary embodiments of the present disclosure may be adapted to provide full transfer details, providing more information, insight, and accuracy to banks. In some embodiments, a system 100 may be adapted to provide money remitter details of all the data collected in order to execute the transfer of money, both sender and receiver information, and links to related documents for all transactions requiring “Currency Transaction Report,” and/or the like. In exemplary embodiments, a system 100 may be adapted to provide detailed reports including agent information; transaction details including dates and amounts; sender details including names, addresses, phone numbers, IDs, etc.; and receiver details, including names, addresses, phone numbers, IDs, and/or the like. In some embodiments, the system 100 may be adapted to allow banks to access all forms filed and maintained by the LMT, and/or the like, for example, CMTs. In some embodiments, the system 100 may be adapted to collect further details for deposits over a predetermined threshold, for example, over $3,000, over $10,000 and/or the like. For example, the system 100 may require an identification type and details associated with the identification and/or a scanned copy of the identification provided by the sender and/or the receiver. In some embodiments of the present disclosure, a system 100 may be adapted to provide access to essential data, thereby empowering banks to query a database and obtain valuable data. A database may be adapted to store and/or organize data such as, for example, CTR verification, OFAC verification, data for pattern analysis, data for transaction analysis, structuring, smurfing, record keeping, rapid response to document requests by federal, state, and/or local agencies, know your customer information, and know your customer's customer information. Exemplary embodiments of the present disclosure may comprise a system 10 adapted to create detailed electronic deposit slips using the processing platform, providing insight into a bank's business; build and access a robust database to better understand deposits on a transaction by transaction basis; harness data and intelligence for the banks to know their customer and their customers' customer, and/or the like.

Methods in accordance with embodiments of the present invention may take place over the network 160, which may comprise a global computer network, for example, the internet. The communications functions described herein can be accomplished using any kind of wired and/or wireless computing network or communications means capable of transmitting data or signals, such as a wireless and/or wired computing network allowing communication via, for example, an 802.11 (“Wi-Fi”) protocol, cellular data protocol (e.g., EDGE, CDMA, TDMA, GSM, LTE), and/or the like. Suitable examples include a packet-switched network, a local area network (LAN), wide area network (WAN), virtual private network (VPN), or any other means of transferring data. The network 160 may be a partial or full deployment of most any communication/computer network or link, including any of, any multiple of, any combination of or any combination of multiples of a public or private, terrestrial wireless or satellite, and wireline networks or links. A single network 160 or multiple networks (not shown) that are communicatively coupled to one another can be used. It is contemplated that multiple networks of varying types can be connected together and utilized to facilitate the communications contemplated by the systems and elements described in this disclosure.

Although FIG. 1 depicts two secondary clients 107₁ and 107n, it should be appreciated that “n” represents any number of clients feasible in accordance with embodiments of the present disclosure. For ease of reference, as used herein, the term “client” may refer to any one or all of the clients, 105, 107₁, and 107ₙ within the system 100. That is, in certain embodiments, multiple clients may perform the same or similar functions. For ease, one client 105 may be referred to herein, however in exemplary embodiments, more than one client 105 may be included in the system 100.

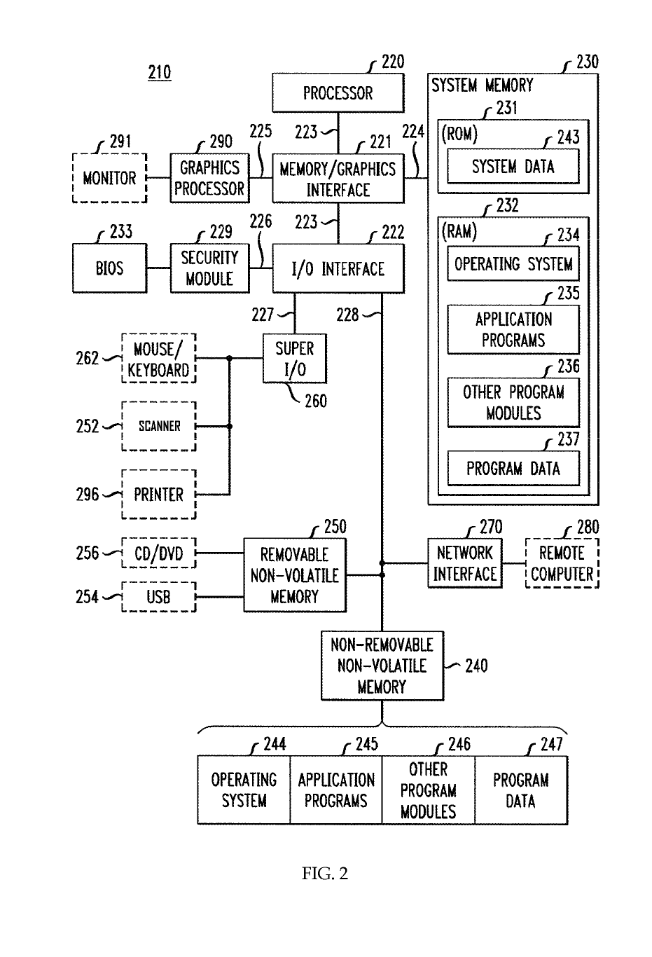

As used herein, the term “computer” may generally refer to any device that is capable of processing a signal or other information. Examples of computers include, without limitation, a personal computer, a portable computer, a handheld computer, a cellular phone, a smart phone, a digital tablet, a laptop computer, a netbook, an Internet appliance, a Personal Data Assistant (PDA), an application-specific integrated circuit (ASIC), a programmable logic array (PLA), a microcontroller, a digital logic controller, a digital signal processor (DSP), or the like, or may generally include a general purpose computer, as discussed below with respect to FIG. 2. A computer may include software in the form of programmable code, micro code, and or firmware or other hardware embedded logic and may include multiple processors which operate in parallel. The processing performed by a computer may be distributed among multiple separate devices, and the term computer encompasses all such devices when configured to perform in accordance with the disclosed embodiments.

The client 105 may generally comprise a communications device, such as a computer. In a basic exemplary embodiment, within the system 100, the client 105 may be capable of transmitting data to and from a host server 115. The host server 115 may host an accessible data portal (e.g., a website or the like). The accessible data portal, which may be accessible to the client 105, may communicate with the client 105 through the network 160. The accessible data portal may comprise any number of security measures to provide a reasonably secure system, suitable for embodiments of the present disclosure. The accessible data portal may further comprise a graphical client interface (GUI) through which a client 105 may access the server 115.

The system may also comprise secondary servers 117₁ and 117ₙ. Although two secondary servers 117₁ and 117ₙ are depicted in FIG. 1, it should be appreciated that “n” represents any number of servers feasible in accordance with embodiments of the present disclosure. For ease of reference, as used herein, the term “server” may refer to any one or all of the servers, 115, 117₁, and 117ₙ within the system 100. That is, in certain embodiments, multiple servers may perform the same or similar functions.

The server 115 may also comprise a database or other sortable data storage memory to enable the system and methods disclosed herein. In many embodiments, the database may be any commercially available data storage database suitable for embodiments of the present disclosure. For example, in one embodiment, the database comprises at least one or more database management systems, such as any of an Oracle, DB2, Microsoft Access, Microsoft SQL Server, Postgres, MySQL, 4th Dimension, FileMaker, Alpha Five Database Management System, or the like. Often contained within the database is a plurality of data sets, each comprising specific data. A first data set may correlate to a first client 105, wherein a plurality of client-specific data is stored. The database may also include any number of subsequent data sets representing N clients, wherein N represents any number of clients practical for operation of embodiments of the present disclosure. In accordance with one embodiment of the present disclosure, any of the servers or clients may comprise a general purpose computer, for example, as shown in the form of a computer 210 depicted in FIG. 2.

FIG. 2 depicts a block diagram of a general computer system, which is capable of being used in connection with the system depicted in FIG. 1, in accordance with embodiments of the present invention. As appreciated by embodiments of the present disclosure, mobile devices, such as mobile telephones, tablets, netbooks, or the like, may be utilized instead a general computer 210 for embodiments of the present disclosure. However, it is also appreciated there is a significant similarity in core components between a mobile device and a general computer 210. The following components are described for exemplary purposes only, and each component's mobile equivalent is also contemplated within embodiments of the present disclosure.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EPROM, flash memory or other memory technology, CD-ROM, digital versatile disks (DVD), blue-ray or other optical disk storage, magnetic cassettes, magnetic tape, magnetic disk storage or other magnetic storage devices, or any other medium which can be used to store the desired information and which can be accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identification information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up. In some embodiments, a security module 229 may be incorporated to manage metering, billing, and enforcement of policies. The security module 229 may comprise any security technology suitable for embodiments disclosed herein.

A super input/output chip 260 may be used to connect to a number of peripherals, such as a scanner 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace. In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A client may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet. In some embodiments, the network interface may use a modem (not depicted) when a broadband connection is not available or is not used. It may be appreciated that the network connection shown is exemplary and other means of establishing a communications link between the computers may be used.

Although the computer 210 of FIG. 2 is described as an exemplary computing device for various applications of embodiments of the present invention, it should be appreciated, a multitude of similar computing devices exist and are equally suitable for embodiments of the present disclosure. It is further understood by embodiments of the present disclosure, a computing device may comprise all of the elements disclosed in FIG. 2, or any combination of one or more of such elements, in order to perform the necessary functions of the embodiments of the present disclosure.

It is understood by embodiments of the present disclosure that a computer, such as the one depicted in FIG. 2, may be connected to a computer network or system. A computer network may include the Internet, a global computer network, an internal computer network, dedicated server networks, or the like.

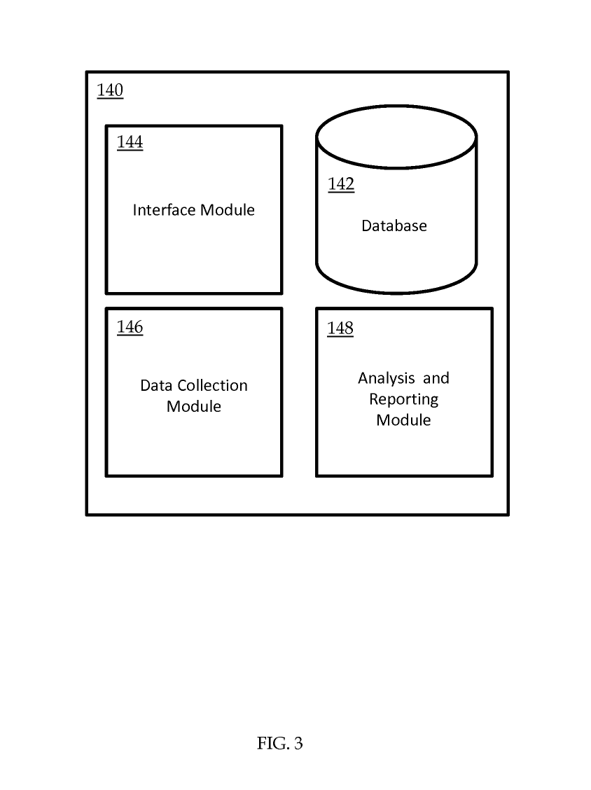

FIG. 3 depicts a block diagram of a system 140 for handling currency in accordance with embodiments of the present disclosure. The system 140 may generally comprise computer executable software and/or instructions configured to perform the functionality of the systems and methods disclosed herein. The system 140 may be stored on a server, on a local computing device, on a mobile communications device, and/or the like. The system 140 may comprise a database 142, an interface module 144, a data collection module 146, an analysis and reporting module 148, and/or the like. In accordance with exemplary embodiments of the present invention, any module may be merged and/or combined with any other module. In some embodiments, additional or fewer modules than those depicted in FIG. 3 may be included.

In exemplary embodiments, the system 140 may be configured to capture, analyze, and store all essential information relating to bulk cash and related transactions. The system 140 may be adapted to collect bulk cash and/or transaction data via one or more data sources, receive the bulk cash and/or transaction data from the one or more sources, analyze bulk cash and/or transaction data, generate alerts if the bulk cash and/or transaction data meets a predetermined condition for suspicious activity, store at least a portion of the bulk cash and/or transaction data, and present a report to a user. In some embodiments, the system 140 may be configured to provide real-time or substantially real-time bulk cash and/or transaction information to users upon request, at predetermined intervals, upon the occurrence of an event such as a deposit, suspicious activity, and/or the like. In exemplary embodiments, the term “user” may generally refer to any party provided with access to the systems and methods in accordance with embodiments of the present invention. For example, a user may comprise a customer, an agent, a remitter, a bank, and/or the like.

In exemplary embodiments, the interface module 144 may be adapted to provide the user with a means for interacting with the system 140. The interface module 144 may be adapted to present a graphical user interface (GUI) to the user, the GUI adapted to allow users to input, view, and interact with the system 140. In some embodiments, the interface module 144 may be adapted to present bulk cash information to a user via a display on a computer, a tablet, a mobile device, a laptop, a touchscreen device, and/or the like. The interface module 144 may also be adapted to provide an opportunity to register a user account for accessing the system 140. User accounts may be restricted to authorized personnel and a verification of a user's identity, such as a social security number or an employee ID number, may be required. In some embodiments, user account requests must be approved by an administrator of the system 140 and/or may only be created by an administrator. The interface module 144 may be adapted to allow a user to run a search query on data stored in the database 142.

Although a single database 142 is depicted in the figures, more than one database or the like, may be included in accordance with embodiments of the present disclosure. For example, an “active” or “working” database may be included in embodiments of the present disclosure. An active or working database may comprise a database storing data for active cash that has not been deposited yet and/or data relating to current transactions. A “historical” or “history” database may be included in embodiments of the present disclosure. A historical or history database may comprise data related to deposits that have already been made, and/or historical data for the entire system, a specific user, a specific transaction type, a group of users, a category of users, a grouping of transactions, and/or the like. The interface module 144 may also be adapted to allow a user to enter data into the data collection module 146.

In accordance with exemplary embodiments of the present invention, the interface module 144 may also allow a user to access bulk cash and/or transaction data generated, filtered, and/or stored by the analysis and reporting module 148. The interface module 144 may be adapted to allow the user to run a report on the data contained in the database 142 with the analysis and reporting module 148 upon request, at predetermined intervals, or upon the occurrence of an event. For example, a user may access bulk cash and/or transaction data upon running a report request with the interface module 144. The interface module 144 may also be adapted to transmit and/or display alert messages to the user when an event occurs and/or an alert is received from the analysis and reporting module 148. An event that triggers an alert may comprise, for example, data that indicates a likelihood of suspicious activity, a likelihood of compliance liability, and/or the like.

In exemplary embodiments, alerts may be presented to the user via a display on a computer or electronic device, via a text or SMS message, via an automated phone call, via email, via an auto-generated letter via postal mail. When an alert is generated, it may be sent to multiple parties. For example, if the analysis and reporting module 148 determines that an event or exception has occurred and an alert should be generated, an alert may be generated and sent via one or more communication means to the agent, the remitter, the bank, the customer, the recipient, one or more legal representatives of any party, and/or the like. The interface module 144 may also be adapted to allow users who are granted sufficient permissions by the administrator to add, delete, and/or modify data saved in the system. Certain data may be completely restricted from modification or deletion, however, such as transaction amount data. The interface module 144 may also be customized by a user and/or an administrator. For example, the interface module 144 may be customized to display bulk cash and/or transaction data in a customized visual format, at certain time intervals, upon the occurrence of an event, or upon request of a user and/or administrator.

In accordance with exemplary embodiments of the present invention, the data collection module 146 may be adapted to receive data from a device, such as a computer and/or the like. In exemplary embodiments, bulk cash and/or transaction data may comprise real-time monitoring data of transactions, data collected during a bulk cash transaction, and/or the like. For example, data in a customer's bulk cash record may comprise a customer's name, birth date, contact information, and/or the like. In accordance with exemplary embodiments, data received from devices via the data collection module during a transaction may include, for example, a deposit amount, a user identifier, a license number, an invoice number, a status identifier, an issued date, an issued time, an amount, a sender sysID, a sender name, a sender identifier, a sender id type, a sender date of birth, a sender address, a sender city, a sender state, a sender zip code a sender phone number, a sender citizenship, a receiver sysID, a receiver name, a receiver ID, a receiver address, a receiver city, a receiver state, a receiver country, a receiver phone, a receiver citizenship, a bank name, a bank branch, an account type, an account number, and/or the like. In exemplary embodiments, the information may be collected via electronic forms, for example, via an electronic deposit slip and/or the like.

In some embodiments, video data may be recorded during a cash transaction with a customer and stored with an associated transaction data record. For example, one or more cameras may be fixed on the area deposits or transactions are made and may record the transaction and/or capture a photograph of the customer while a transaction is taking place and associate the video and/or still photograph with a transaction record. In some embodiments, the system may include face recognition or similar software adapted to identify an individual from a video or still image and cross reference the identification with a database of registered customers and/or a third party website, such as a national security database, and/or the like. In some embodiments, an alert may be generated if the identification of the user matches the identification of a user in a criminal and/or national security database, or the like. The cameras may be motion sensitive and may follow designated individuals. In exemplary embodiments, audio data may be captured that may comprise any audio data captured by an audio capture device in the deposit area. In some embodiments, the captured audio may be used to identify a user, with the same or a similar process to the one used for identifying the user with a video file or a still image.

In some embodiments, if the bulk cash and/or transaction data collected is designated as essential by a user and/or administrator, the essential data is forwarded to the analysis and reporting module 148. By way of example, essential data my include sender identification, transaction amounts, transaction dates, and/or the like. In some embodiments, if the bulk cash and/or transaction data collected is designated as non-essential by a user and/or administrator, the non-essential data is not forwarded to the analysis and reporting module 148 and is saved in the database 142 without further analysis. In accordance with exemplary embodiments, the database 142 may be adapted to store all bulk cash and/or transaction data in accordance with the present invention.

In accordance with exemplary embodiments of the present invention, the analysis and reporting module 148 may be adapted to analyze bulk cash and/or transaction data collected by the data collection module. The analysis and reporting module 148 may be adapted to apply one or more algorithms or sets of rules against data collected by the data collection module 146. The analysis and reporting module 148 may be adapted to find and/or identify data that indicates suspicious activity, such as a pattern of deposits broken up under a predetermined threshold deposit amount, and/or potential compliance liability.

The analysis and reporting module 148 may be adapted to flag and identify potential liability risks and present the risk(s) to a user and/or administrator via an alert, a report, or upon request from the user and/or administrator. The analysis and reporting module 148 may compare the collected bulk cash and/or transaction data with best practices data indicating a range of proper deposit values and/or timeframes for given set of bulk cash and/or transaction data. Best practices data may generally be set by regulatory requirements, by banks, by remitters, and/or the like. If the collected bulk cash and/or transaction data does not fall within the best practices data ranges, an indication that potential compliance issue has occurred may be generated and an alert reporting the issue may be generated. When a known suspicious activity condition is met, such as a pattern of deposits under a predetermined threshold, the analysis and reporting module 148 may be adapted to notify the bank, the remitter, the agent, and/or the administrator via the interface module 144. The analysis and reporting module 148 may also be adapted to generate reports and/or alerts comprising a summary of all customers, any error conditions for specific customers and/or the like. The reports and/or alerts may be transmitted and/or displayed to the user via text or SMS message, mobile communication device, email, postal mail, a report generated on the display of a computing device, and/or the like.

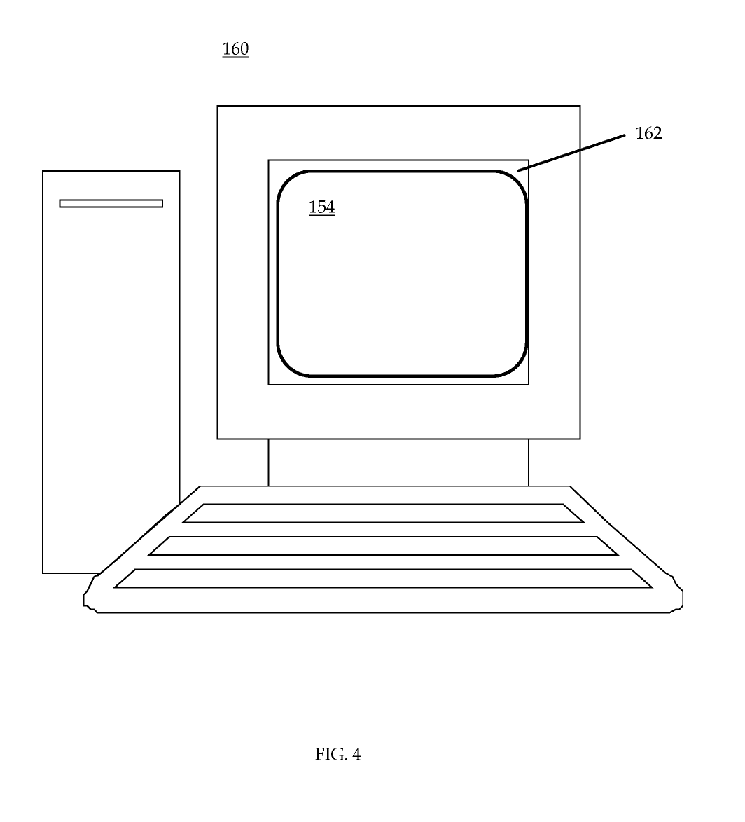

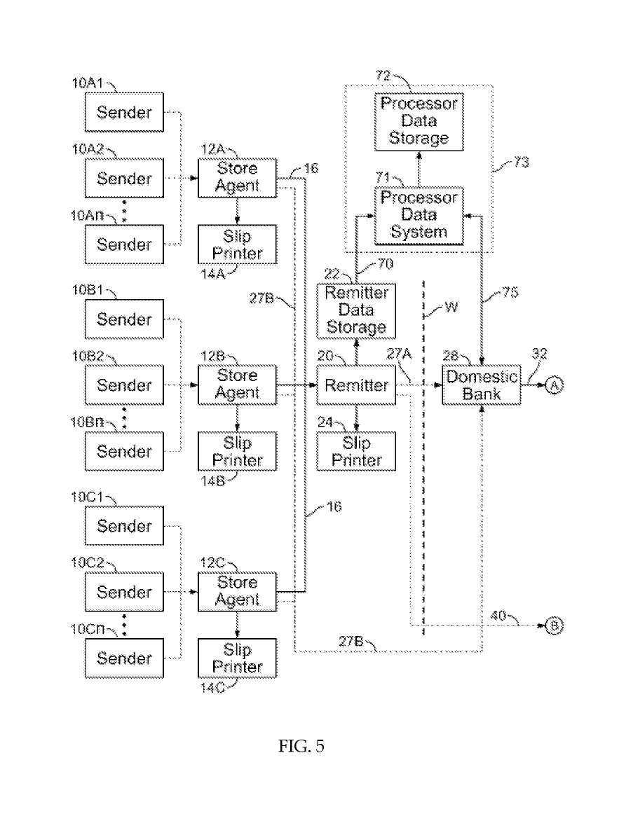

FIG. 4 depicts an exemplary client computer 160 capable of being used with the system depicted in FIG. 1, in accordance with embodiments of the present invention. In exemplary embodiments, the client computer 160 may comprise a display 162. The display 162 may be adapted to display at least an interface 154. In exemplary embodiments, the functionality and appearance of the display may be determined by an interface module. The interface 154 may be adapted to display any data and analysis collected, stored, and/or analyzed by a system in accordance with embodiments of the present invention. Although a client computer 160 is depicted as a personal computer in FIG. 5, any computing device may be used. By way of example, a mobile phone, a tablet computer, a laptop computer, and/or the like may be used, to name a few.

Referring to FIG. 5, this system diagram shows an exemplary overall arrangement for transferring money or other monetary benefit from (a) senders 10A1, 10A2, . . . 10An, (these agents can be of any number and are referred to as senders 10A); (b) any number of senders 1081, 10B2, . . . 10Bn, (referred to as senders 10B); and (c) any number of senders 10C1, 10C2, . . . 10Cn (referred to as senders 10C). Senders 10A, 10B and 10C are referred to collectively as customers 10. Receivers 50A1, 50A2, 50A3, 50B1, 50B2, 50B3, 50C1, 50C2, and 50C3 are referred to collectively as receivers or beneficiaries 50.

Customers 10A, 10B, and 10C, may visit agents 12A, 12B, and 12C, respectively, to initiate a transaction. Agents 12A, 12B, and 12C (collectively referred to as agents 12) may comprise local consumer goods stores offering a money transfer service, and local outlets dedicated to facilitating money transfers. The number of customers 10 and agents 12 can, in general, vary from that illustrated in FIG. 5.

Agents 12 may be connected over network 16 to a remitter 20. Network 16 may be implemented by a web based program, a switched telephone network (STN), wireless cellular phone service, cable networks, satellite links, and the like, using an Internet protocol, asynchronous transfer mode technology, any network technology described herein, and/or the like. Information downloaded by remitter 20 over network 16 into the database in storage device 22 may be encrypted using any one of a variety of known encryption methods, e.g. public-key cryptography.

Agents 12 may have computer-based equipment that may run software applications specifically dedicated to conducting secure communications over network 16 with computer-based equipment operated by remitter 20. Alternatively, agents 12 may simply have an Internet browser that logs into a secure web server operated by remitter 20. In still other cases, agents 12 may communicate by email or simply by telephone or through paper communications.

These and other computer-based equipment may be implemented by software running on autonomous computers or in a distributed computing environment where tasks are performed by remote processing devices that are linked through a communications network. The relevant software applications can operate on a variety of well-known computing systems, such as personal computers, server computers, hand-held or laptop devices, multiprocessor systems, microprocessor-based systems, minicomputers, mainframe computers, and the like.

The computer-based equipment operated by remitter 20 is shown employing as storage media, hard drive 22, which may contain a database holding transaction information from agents 12, to be used in a manner to be described presently. Also, the computer equipment operated by remitter 20 may a printer 24, or the like. In addition, the computer equipment operated by agents 12A, 12B and 12C may include printers 14A, 14B and 14C, respectively (these printers being collectively referred to as printers 14). Printers 14 and 24 are referred to as generators and may be operable to produce deposit slips, in a manner to be described presently. In some paperless embodiments, the deposit slips may only appear on computer monitors and may therefore be produced as a virtual deposit slip.

Generation of a deposit slip, virtual or otherwise, by a system in accordance with exemplary embodiments of the present disclosure and/or receiving, processing, or generating the deposit, may generate a transfer of data from a “working database” to a “history database,” or the like. Exemplary “working databases” and “history databases” are described herein, supra. In exemplary embodiments, a deposit slip may represent not just a deposit of bulk cash but also the acknowledgement of a LMT that the makeup of the deposit has a required documentation for every dollar sent, another acknowledgement, and/or the like. In exemplary embodiments, the deposit slip may be configured to perform functions beyond the cash deposit function. For example, a deposit slip may transfer or assist in transferring data from database to database, such as from a working database to a history database, or the like. In some embodiments, a deposit slip may verify that documentation, or the like, is in place for monies transferred, or the like.

A data storage device 22 maintained by remitter 20 may store all information provided by agents 12, together with any relevant information or annotations produced by the remitter. A service provider 73 is shown having a computer based processor 71 coupled to a data storage device 72 (device 72 containing a primary database). Processor 71 may be coupled over network 70 to the remitter's storage device 20 in order to download information therefrom in a database to database transfer (equivalently, one could say remitter 20 uploads information to the database in storage device 72). Network 70 may be an electronic link and may use technology previously described in connection with network 16. While only individual remitter 20 is shown communicating with service provider 73, it may be understood that in practical embodiments, multiple remitters may be coupled to provider 73 to take advantage of the provider's services, which may be described presently.

Remitter 20 is shown connected by link 27A to a financial institution, in this case domestic bank 28. Agents 12 are also shown connected to bank 28 by a different link 27B Link 27A (as well as link 27B) represents any common form of making cash deposits in a financial institution including physical walk-ins, armor car delivery and ACH from another financial institution. Link 27A and 27B may also consist of using any traditional form of requesting a wire including a faxed wire request, a telephone wire request and a web based wire request.

Financial institution 28 can be any one of various types of institutions, such as a bank or non-bank financial institution, as well as: an investment bank; a merchant bank; a securities firm; a commercial bank or trust company; a private banker; a credit union; a thrift institution; a money services business; a foreign bank or foreign financial agency; any organization chartered under the banking laws of any state and subject to the supervision of the bank supervisory authorities of a State; a bank organized under foreign law; a national banking association or corporation; or the like. For the purposes of this specification, a financial institution can also include any individual, a corporation, a partnership, a trust or estate, a joint stock company, an association, a syndicate, joint venture, or other unincorporated organization or group and any entity involved in making, facilitating or receiving an electronic payment or wire transfer.

Bank 28 may have a sophisticated computer-based system for serving its usual business activities. This system may be supplemented with additional software modules for accessing information made available by service provider 73 over network 75 from database 72 of processor 71.

Information available from provider 73 through database 72 may include information from remitter 20 previously sent to the provider's storage device 72 via network 70, thereby making available a database of transaction information uploaded by the remitter. Storage device 72 can be a hard drive dedicated to storing information from the remitter 20 or can be part of a larger storage system used by processor 71 to keep track of information normally stored by a financial institution and a remitter.

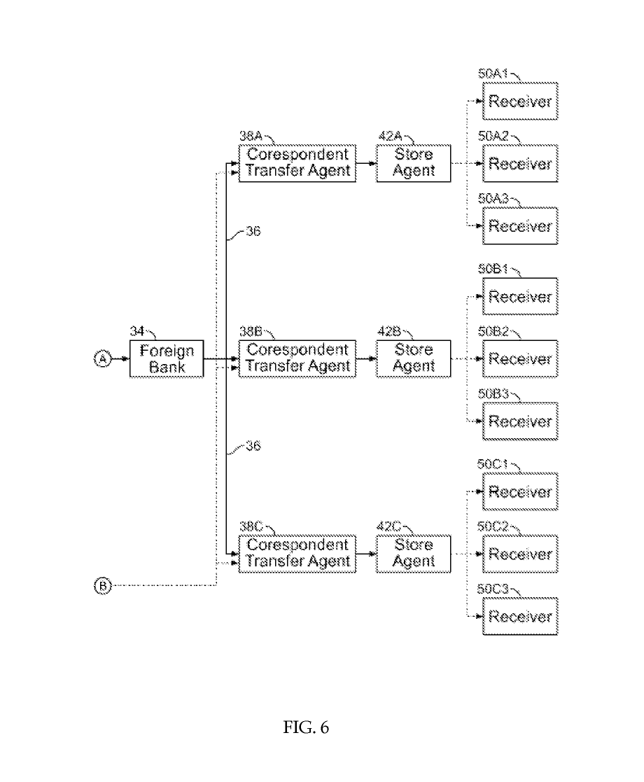

FIG. 6 illustrates a continuation of the schematic diagram of a system for handling currency in accordance with embodiments of the present invention. Bank 28 may have relationships with corresponding financial institutions for implementing wire transfers. One such financial institution is shown as foreign correspondent bank 34, and typically, additional relationships may exist with other domestic banks or with a variety of other appropriate financial institution, although these other relationships are not shown to simplify this description.

Correspondent bank 34 is shown communicating over network 36 to any one of transfer agents 38A, 38B and 38C (these transfer agents being collectively referred to as transfer agents or recipients 38). While agents 38 are shown as being three in number, in many cases the number may be different. Agents 38 have pre-established accounts with bank 34 that allow remitter 20 to instruct bank 28 to implement wire transfers into the respective accounts of agents 38.

Remitter 20 can use independent communications link 40 to notify affected agents 38 of wire transfers being sent to an agent's account in bank 34. In some cases communications link 40 may be the Internet, although other types of links may be used instead. As described further hereinafter, notices sent over link 40 may include information about the transactions originating from sender-customers 10.

Each transfer agent 38A, 38B and 38C is shown linked to a consummating agent 42A, 42B and 42C, respectively. Although this is shown as a one-to-one relationship, in most practical arrangements, each of the agents 38 may be linked to multiple local consummating agents. These agents 42 (i.e., agents 42A, 42, B and 42C) are similar to previously mentioned agents 12, that is, agents 42 may be a local consumer goods store offering a money transfer service, or a local outlet dedicated to money transfers. Basically, consummating agents 42A, 42B and 42C may disburse funds to beneficiaries 50A, 50B and 50C, respectively.

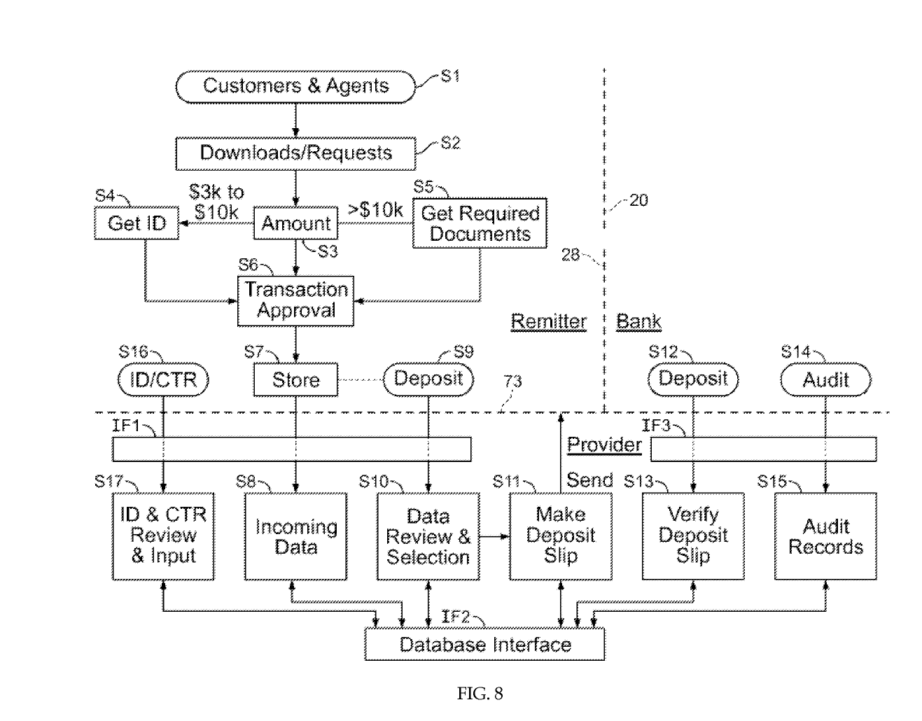

To facilitate an understanding of the principles associated with the foregoing system, its method of operation may be briefly described. As an illustrative example, one of the customers, customer 10A1, arrives at agent 12A with cash intended to benefit beneficiary 50A3. Customer 10A1 delivers the cash to agent 12A, which may include an appropriate service fee. Agent 12A may examine identification presented by customer 10A1 and record that customer's name, address, telephone number, identification number, as well as the name and address of the intended beneficiary. For larger transactions, agent 12A may make a photocopy of the identification presented by customer 10A1. This process is shown in the flowchart of FIG. 8 as initial step S1.

In step S2 of FIG. 8, remitter 20 may download from agent 12A over network 16 (FIG. 5) the transaction information supplied from agent 12A. It is assumed herein that step S2 is part of a computer-based system operated by remitter 20, although some remitters may operate a manual system relying on telephone or paper records. For now, it may be assumed that the download relates to the most recent transaction just described (and not an independent deposit or other request), in which case step S3 may be executed. The download can include not only typed information, but also images of identification presented by customer 10A1.

Next, the monetary amount of the downloaded transaction may be analyzed in step S3. If the transaction exceeds $3,000.00 (but not $10,000.00) step S4 may be executed, where the sufficiency of identification provided by customer 10A1 may be examined by remitter 20. For example, if a driver's license was presented, agent 12A may be required to record the State and possibly the driver license number.

Step S4 may be automatically performed with prompts generated by software running on the computer-based equipment at the office of remitter 20. Alternatively, remitter 20 may simply be expected to examine the transaction information supplied from agent 12A, notice the transaction exceeds $3,000.00, and personally verify that the identification information is sufficient and maintain a copy of the identification presented. If operating an automated system, remitter 20 may be given appropriate warnings at this juncture about the required information.

If the transaction amount exceeds $10,000.00 step S5 may be executed instead of step S4. For this larger transaction remitter 20 must verify agent 12A has obtained an image of the photo ID provided by customer 10A1. This image may be included in the supplied transaction information and, in computer-based systems, may be displayed on a computer screen for inspection by remitter 20. Also, software running at the office of remitter 20 may notify the remitter of the need to complete a Currency Transfer Report (CTR). Remitter 20 can now call up a CTR form with blanks that can be filled out, either manually or automatically. After completing the CTR form, remitter 20 can immediately or later send the form electronically to the appropriate governmental agency, or simply print the form on printer 24 (FIG. 5) for subsequent mailing.

Step S6 of FIG. 8 may be executed either: (1) after satisfying the requirements of step S4 or step S5 (each of these two steps being referred to as diverted activity), or (2) directly without intervening steps S4 or S5, if the transaction amount is determined to be less than $3,000.00 in step S3. In step S6 remitter 20 may have a final opportunity to review the proposed transaction and decide whether to approve it.

At this time remitter 20 may have an opportunity to review prior activity by agent 12A. For computer-based systems, this review can be accomplished by allowing remitter 20 to click on a link (not shown) that may bring up the prior records of agent 12A and related customers of 12A (for purpose of this example, customers 10A1, 10A2, and 10A3). Remitter 20 can examine the reliability of agent 12A, that is, whether prior transactions caused problems, and whether the agent promptly delivered funds to support those transactions. If the history of agent 12A is troubled, remitter 20 may disapprove the transaction. Moreover, even if agent 12A has an unblemished history, remitter 20 may disapprove the transaction because of its size or because of an unusually high frequency of transactions. The proposed transaction can also be disapproved because agent 12A did not provide enough information to satisfy steps S4 or S5.

If the proposed transaction is disapproved control is returned to step S2 to await future downloads from agents 12, or future requests/instructions from remitter 20 or agents 12. If however the transaction is approved, the transaction is stored in step S7 to the remitter's storage device (i.e., the database in device 22 of FIG. 5).

Subsequent to step S7, the remitter 20 may automatically upload the latest transaction to service provider 73 (through processor 71 into the primary database of storage device 72 of FIG. 5). This stored information can be maintained for many years, for example, five years or more. This transfer may be accomplished through interface IF1, employing appropriate handshaking protocols and secure data streams. This transfer is accomplished over network 70 of FIG. 5.

Processor 71 (FIG. 5) of provider 73 may have computer-based equipment to receive this incoming information and, in step S8 (FIG. 8), store the incoming information in storage device 72 of F1G. 5 using the database interface IF2 of FIG. 8. Alternatively, remitter 20 may defer uploading transaction information and may later upload multiple transactions as a batch. In still other cases, independently of remitter 20, provider 73 (FIG. 5) may fetch data from remitter 20 (from storage device 22 of FIG. 5). This fetching may be done on a predetermined schedule or based on a conscious decision made by the provider.

After steps S7 and S8, step S9 can be performed either immediately or be postponed for a more convenient time. Step S9 involves making a deposit and can be initiated by either remitter 20 or one of the agents 12. Whether now or later, agent 12A must eventually seek authorization to make a deposit into the account of remitter 20 (i.e., a deposit into bank 28 of FIG. 5).

If this deposit request is deferred, step S7 returns control to step S2 to await further downloads or instructions. In some cases, a deposit request is deferred by agent 12A until the agent has accumulated funds from a number of customers at which time, agent 12A can request to make a bulk deposit without contemporaneously recording a new transaction, in which case step S9 is accessed peremptorily, bypassing steps S1-S8. In the simplest case, agent submits via email or telephone to remitter 20 a request to receive a deposit slip and permission to bring bulk cash to bank 28 for deposit. In such a case remitter 20 may initiate step S9 instead of agent 12A.

Whenever a deposit request is made, this request may go through a process that is facilitated by a feature implemented by processor 71 (FIG. 5) and shown in FIG. 8 as step S10. As noted, the deposit request may involve only the above described single transaction by agent 12A just approved by remitter 20, or the deposit request might cover several prior transactions from agent 12A.

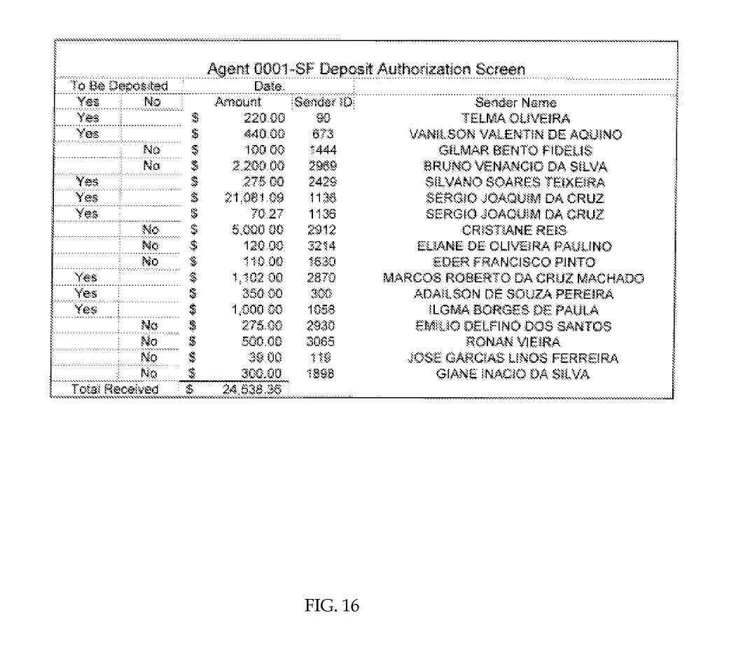

In step S10 remitter 20 accesses the service provider's program running on processor 71 (FIG. 1) to select specific transactions, either those identified by agent 12A or selected by remitter 20 from among the agent's recent transactions. To implement this selection, remitter 20 may identify agent 12A and in response processor 71 may use interface IF2 to fetch corresponding information from the primary database in storage device 72 in order to present to the remitter the screen shown in FIG. 16. This screen shows all outstanding transactions of agent 12A for which funds have yet to be deposited. In the example of FIG. 16, seventeen transactions (totaling $24,538.36) are listed as outstanding, two from the same sender-customer. Remitter 20 may consider the deposit request from agent 12A, which may usually include an actual deposit amount proposed by the agent.

Frequently, the proposed deposit amount may not precisely correlate with any subset of the outstanding transactions. This disparity may result from rounding the deposit amount, or from deferring some transactions, or from increasing the deposits to account for prior or future deferrals. Remitter 20 may be given the discretion in the screen of FIG. 16 to select less than all of the seventeen display transactions. In this case, remitter 20 has selected eight transactions by clicking the “Yes” column for them. The selection of transactions may be based on an internal set of compliance criteria.

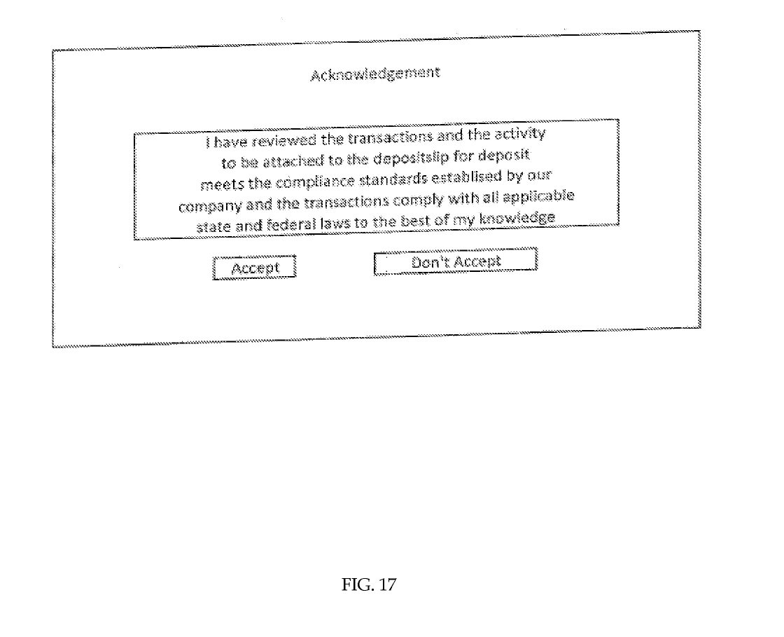

After selecting transactions for deposit from the screen of FIG. 16, processor 71 may prompt the remitter as shown in FIG. 17 to acknowledge having reviewed the transactions and passed the transactions through its internal compliance protocols. If remitter 20 accepts this acknowledgement, the deposit information may be recorded in storage device 72 of F1G. 5, using the database interface IF2 of FIG. 8. As explained further hereinafter, such storage makes the transactions and the deposit information available to the relevant financial institution (bank 28 of FIG. 5) for review and query.

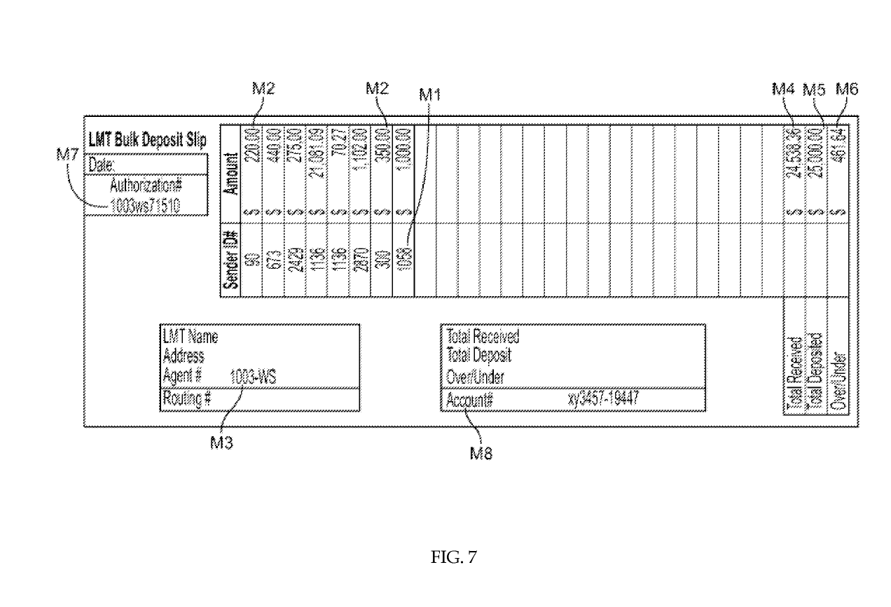

Processor 71 may now continue to step S11 and generate the deposit slip of FIG. 7 and automatically either (a) print it out on the remitter's printer 24 (FIG. 5) for hand delivery to agent 12A; or (b) email it to the remitter 20 for subsequent printing on the agent's printer 14A.

The deposit slip example of FIG. 7 shows the eight transactions previously marked “yes” in FIG. 16 against agent 12A. Markings M1 appearing under the heading “Sender ID #” constitute unique codes signifying customers 10A1, 10A2, 10A3, 10A4, 10A5, 10A6, 10A7, and 10A8 of agent 12A. In this example, customer No. 1136 has two entries, indicating two distinct transactions by that customer. Markings M2 under the heading “Amount” signify transaction amounts associated with each of the markings M1 for customers 10A1-10A8. In this embodiment the deposit slip of FIG. 7 may be dedicated to a single agent, agent 12A, whose identity may be indicated by marking M3 (“1003-WS”), a unique code signifying agent 12A. Accordingly, the listings M1 and M2 may not relate to any other agents.

The eight transaction amounts listed by markings M2 are automatically totaled and displayed as marking M4. While the total represented by marking M4 signifies the amounts actually received by agent 12A, in practice the agent does not always deliver that precise amount. Often the amount delivered is rounded up or down or may include additional funds to accommodate prior deficiencies or expected future deficiencies. The actual amount of bulk cash that may be delivered is designated as marking M5, in this example $25,000.00.

The difference between the amounts of markings M4 and M5 are displayed as marking M6, in this case $461.64. While an excess may be delivered in this case, in other cases the delivered amount M5 may be less than the total M4 and this deficiency may be indicated either by a preceding minus sign or by embracing the difference in parentheses.

Remitter 20 may be able to review the deposit slip of FIG. 7, paying special attention to marking M6, which gives a summary of any discrepancy between (a) the total M4 of transaction amounts M2, and (b) the bulk cash that is to be delivered, indicated by marking M5. If the amount of bulk cash M5 is much less than the transaction total M4, remitter 20 may become concerned that agent 12A is misappropriating funds. If the amount of currency M5 greatly exceeds the transaction total M4, remitter 20 (or financial institution 28) may suspect money laundering. If the deposit seems inappropriate, remitter 20 may refuse future deposit requests until the situation is resolved; or the financial institution 28 may suspend the account until the situation is resolved. At this time remitter 20 or financial institution 28 may need to take appropriate step to bring the agent 12A into compliance and may also need to take steps to notify authorities of perceived unlawful activity.

The deposit slip of FIG. 7 may ultimately be given an authorization code shown as marking M7 after approval. In this example, following step S11 of FIG. 8, the deposit slip of FIG. 7 may upon receipt by remitter 20, be emailed to agent 12A. Agent 12A may print the deposit slip using printer 14A of FIG. 5.

Accordingly, requests for a deposit slip can only be requested by an authorized representative of the agent 12A and completed by the remitter 20.

Once remitter 20 delivers the deposit slip of FIG. 7 via email (or by fax or hand delivery) to agent 12A, the agent is now authorized to bring bulk cash to bank 28 for deposit. When agent 12A brings bulk cash to bank 28, the teller may be trained to access the service provider's program via step S12 and enter the account number (marking M8) and authorization number (marking M7).

The system employed by bank 28 may then connect over network 75 (FIG. 5) to processor 71 of FIG. 5, this connection being indicated in FIG. 8 as step S12, shown negotiating through interface IF3 to execute appropriate handshaking and security features. In succeeding step S13, deposit information corresponding to the identified authorization and account number may be downloaded through database interface IF2. Next, processor 71 (FIG. 5) may request the teller to confirm the amount of bulk cash being deposited into the account of remitter 20. This information may be uploaded to the processor database 72 via network 75 and may be used to create the over/under running balance of the agent 12A.

Accordingly, the over/under amount, described as marking M6 of FIG. 7, may be confirmed at the moment agent 12A delivers cash to the financial institution (bank 28 of FIG. 5). The bank teller may have access to the data stored in storage device 72 by processor 71.

An invalid deposit or deposit slip may be rejected by processor 71, which may then inform the teller of the invalidity of the deposit. If however the deposit is valid, the deposit may proceed as if it were a normal, simple cash deposit. Immediately or sometime later, remitter 20 may confirm that agent 12A has deposited the designated funds with bank 28.

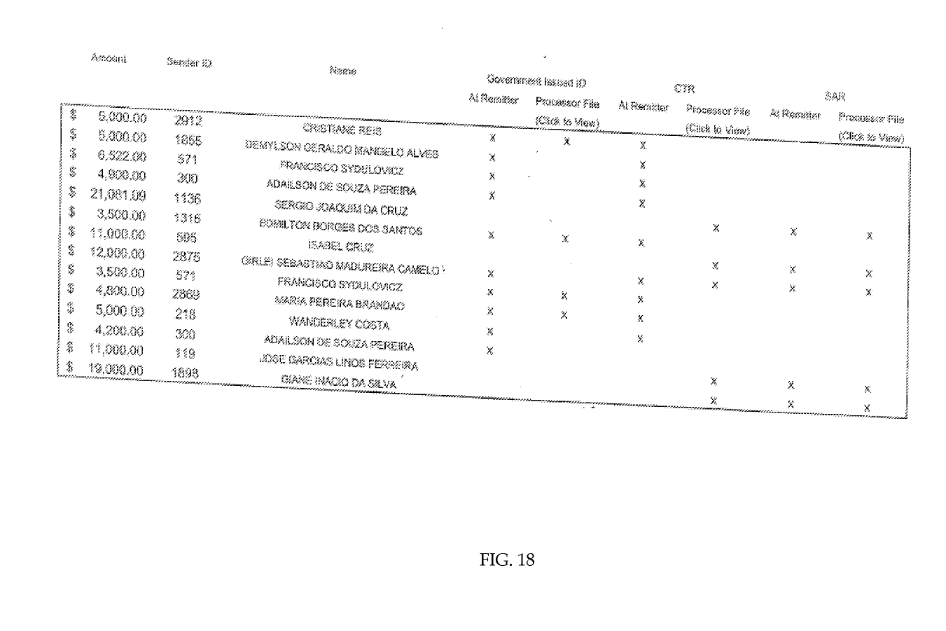

Remitter may at some convenient, arbitrary time initiate step S16, which establishes a connection through interface IF1 over network 70 of FIG. 5. Specifically, in succeeding step S17 processor 71 may fetch data from storage device 72 concerning any transactions for any of the agents 12 (not just agent 12A) that amount to at least $3,000.00. The fetched data may be presented to remitter 20 as shown in the screenshot of FIG. 18. So for this example, the deposit slip of FIG. 7 had only one such transaction, which is reported as the fifth item in the listing of FIG. 18. Accordingly, remitter 20 can identify missing data (FIG. 18) and choose to enter this data. The data requested may be ID's, CTR's and SARs. The remitter 20 (and as described further hereinafter financial institution 28) may use this data to determine compliance risk levels.

Description may now be made of the ability of financial institution 28 to access information stored by service provider 73. Accordingly, one of the advantages of the system is that financial institution 28 effectively has comprehensive access to the transaction information normally held in the database of storage device 22 operated by remitter 20. In the past, this information was unavailable to financial institution 28 and there existed a virtual wall W between remitter 20 and financial institution 28. With the present system, financial institution 28 can obtain detailed information about the transactions underlying the deposits of remitter 20 by accessing database 72 through processor 71 of service provider 73.

Specifically, in step S14 bank 28 can request information about specific deposits made at the bank via a set a queries conveyed through interface IF3. This request launches step S15 and an associated program module running on processor 71 of FIG. 5. The requested data fields can be, but are not limited to, any set of fields or combination of fields regarding date, amount, agent, agent's teller, street address, town, state or province, zip code, ID type, ID#, beneficiary name, beneficiary address, beneficiary phone number, or beneficiary bank. Financial institution 28 can view the requested fields or request a report. Processor 71 may return a report in limited format about the search.

In step S15 processor 71 generates a report showing fields that can have copious data (FIG. 18). Some fields provide access to copies of ID's for transactions over $3,000, copies of ID's and CTR reports for transactions over $10,000 and copies of SAR reports when filed on suspicious activity and copies of sender ID's when obtained based on a remitter's own compliance criteria.

So for example, the first line (Cristiane Reis) exceeds $3,000.00 but not $10,000.00 and indicates a copy of the sender's ID is held by the remitter and that an electronic copy can be viewed by clicking on the second column following the sender's name. For this transaction remitter 20 also has a copy of a CTR, but has not provided an electronic copy for viewing online. Also, no SAR has been created. If bank 28 believes the foregoing backup information should be supplemented or corrected, the bank can request remitter 20 to respond appropriately.

The last line of FIG. 18 shows a transaction exceeding $10,000.00 but with no sender ID available. A CTR is available only online and an SAR is available at the remitter and online. This transaction appears irregular and bank 28 may need to take corrective action and investigate the nature of this transaction.

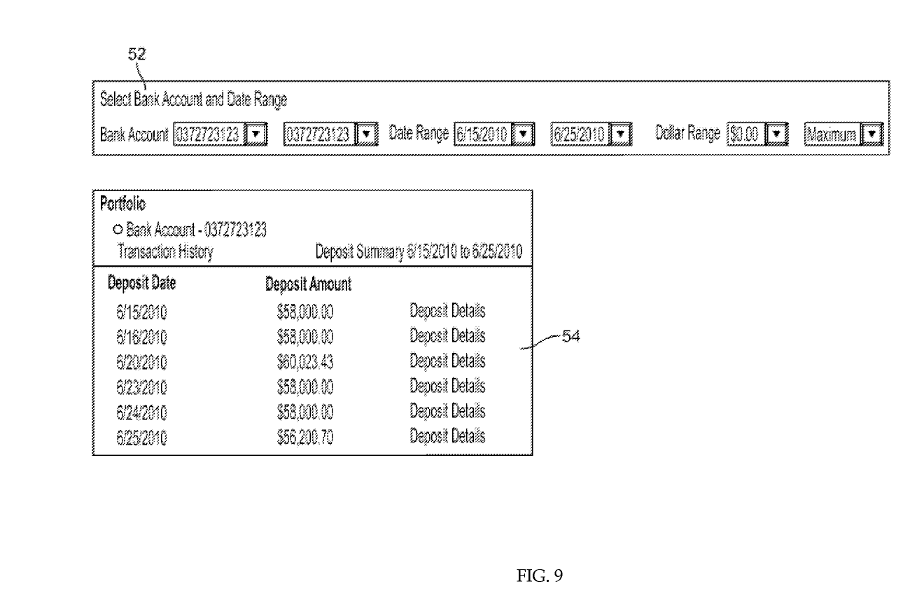

In general, financial institution 28 can fetch information from the primary database on storage device 72 using a variety of filtering queries. In the exemplary screenshot of FIG. 9, personnel at financial institution 28 have used the drop-down, editable menus in header 52 to select the account of remitter 20. In this hypothetical example the operator selected only account number 0372723123, although a second account can be selected through the second drop-down menu. The hypothetical date range selected by the next two drop-down menus is from Jun. 15, 2010 to Jun. 25, 2010. The final two drop-down menus specifies a dollar range from zero to maximum. In response, the system provided below in block 54 the requested deposit listing.

The foregoing listing of FIG. 9 may be inadequate for many purposes, especially for audits conducted by regulatory agencies. If additional information is required, an operator can click on one of the deposit items listed in block 54 of FIG. 9. For the purposes of the present explanation, it may be assumed that the operator selected the third item (Jun. 20, 2010) by double-clicking on it, although any of the other items could have been selected instead.

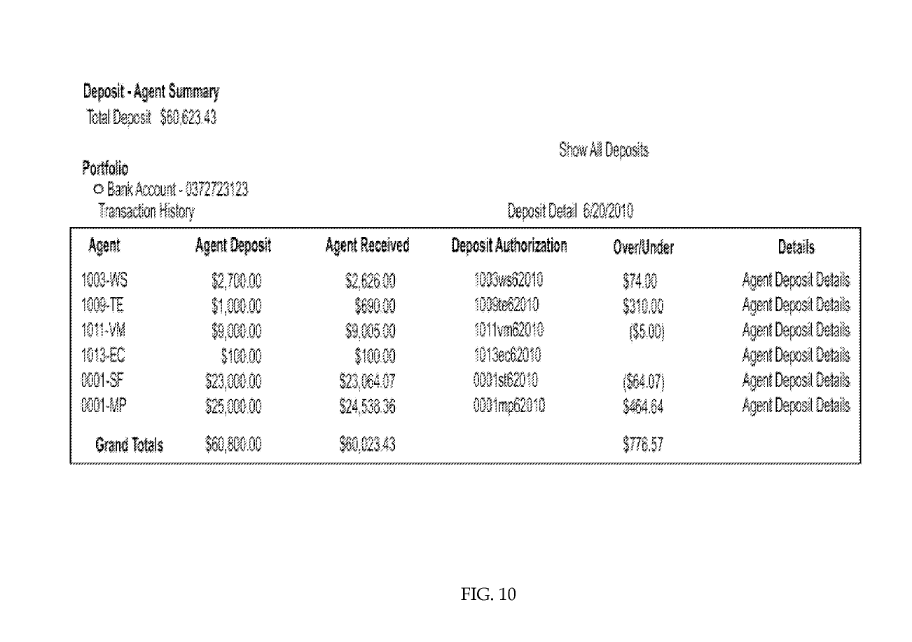

In response, the system at provider 73 executes a different filtering query and provides further details about the deposit of Jun. 20, 2010, as shown in the screenshot of FIG. 10. This screenshot shows the identification code of six different agents (six of the agents 12 of FIG. 5). (The deposit slip of FIG. 7, gives an identification code for a single agent as marking M3.) The screenshot of FIG. 10 also lists for each of the six agents, the amount deposited (compare with marking M5 of FIG. 7), the amount received (compare with marking M4 of FIG. 7), the deposit authorization code from remitter 20 (compare with marking M7 of FIG. 7), and the over/under amount (discrepancy marking M6 of FIG. 7). The two last columns in FIG. 10 (Details and Branch #) may include other information deemed useful by the financial institution.

The foregoing listing of FIG. 10 may still be inadequate for many purposes, especially for investigations of suspicious banking activities. If additional information is required an operator can click on any one of the agents listed in FIG. 10. For the purposes of the present explanation, it may be assumed that the operator selected the last item (Agent 001-MP) by double-clicking on it, although any of the other agents could have been selected instead.

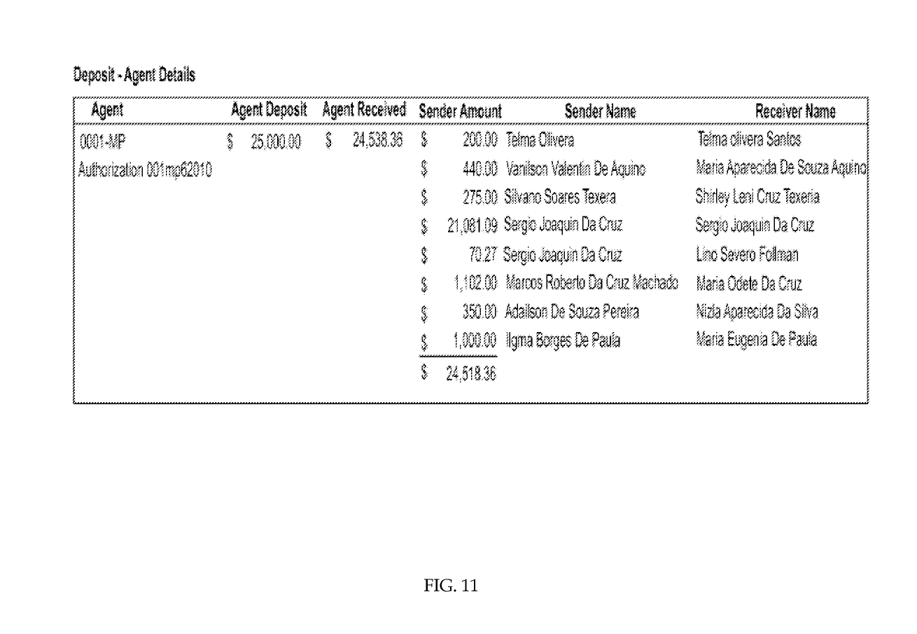

In response, the system at provider 73 executes a different filtering query and provides further details about the deposit by agent 001-MP on Jun. 20, 2010, as shown in the screenshot of FIG. 11. The screenshot shows again the agent's identification code, the deposit authorization code, the amount deposited ($25,000.00), and the amount received ($24,538.36). In this case the amount received originates from seven senders, one of the senders executing two transactions. Specifically, FIG. 11 lists the amount sent (compare with marking M2 of FIG. 7), the name of the sender, and the name of the receiver.

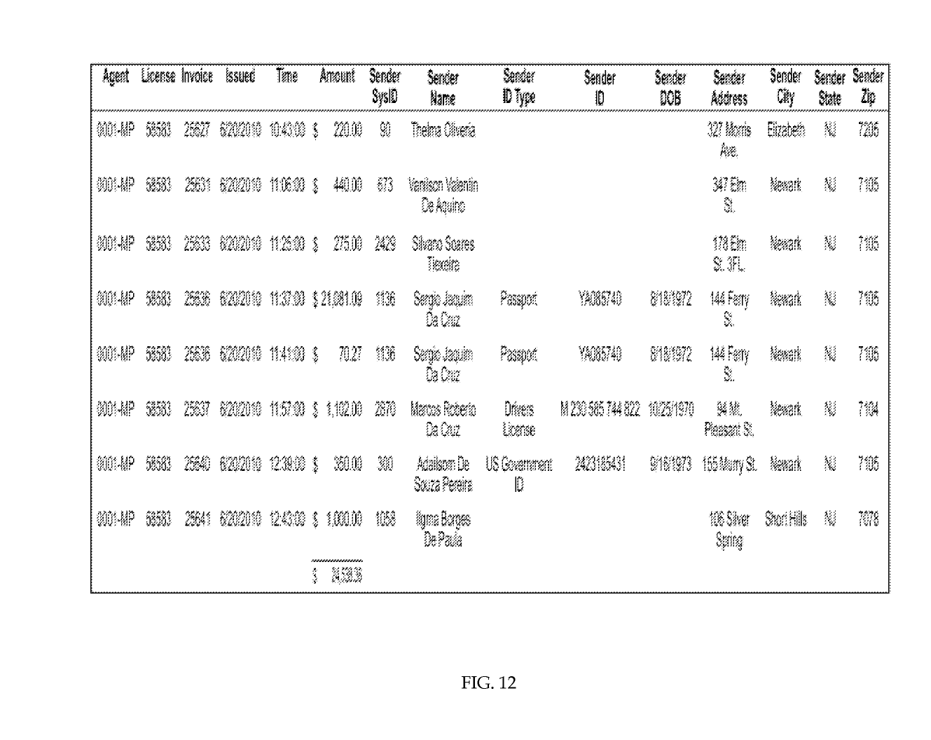

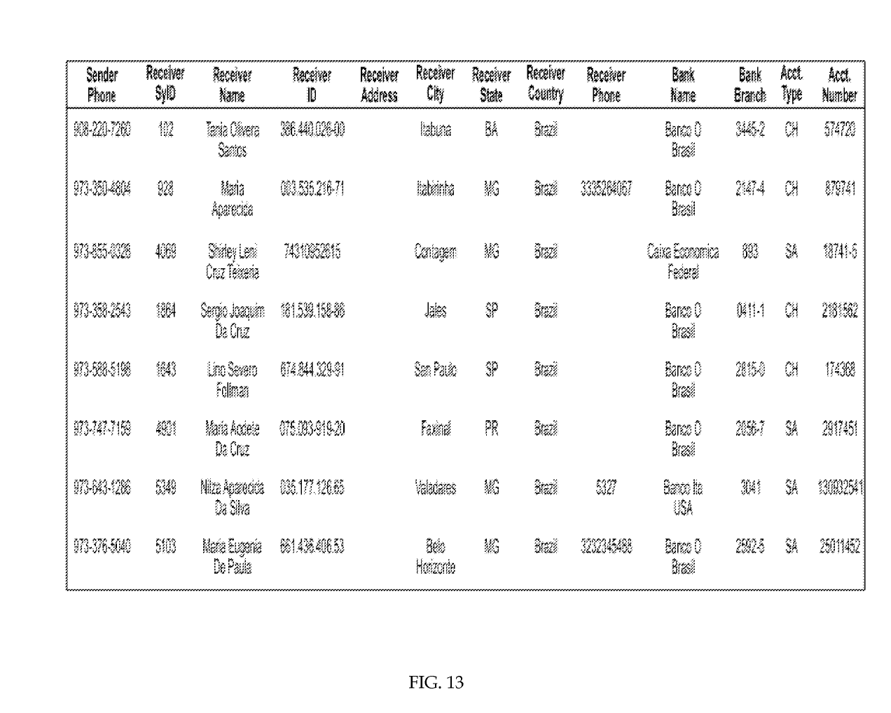

The operator may be given the option of expanding the information presented in FIG. 11 into the full data listing illustrated in FIGS. 12 and 13. FIG. 12 lists the agent ID (0001-MP), the agent's license number (58583), the invoice number generated for each of the eight transactions listed, the transaction date and time, monetary amount sent (compare with marking M2 of FIG. 7), sender ID (compare with marking M1 of FIG. 7), sender-customer name, sender-customer ID type (driver's license, passport, etc.), sender-customer ID (e.g., driver's license number), sender-customer's date of birth, and the sender-customer's street address, city, state and zip code.

FIG. 13 lists in the first column the sender-customer's telephone number, while the rest of the columns relate to the receiver (beneficiary). The receiver information includes: receiver sys ID (a unique receiver ID code automatically generated by the system at runtime); the receiver's name; receiver ID (a receiver ID code with additional digits useful for encoding additional information about the receiver); the receiver's street address, city, state, and country; the receiver's telephone number; bank name (i.e., bank 34 of FIG. 5); bank branch; and account type and number (for the accounts of agents 38 of FIG. 5).

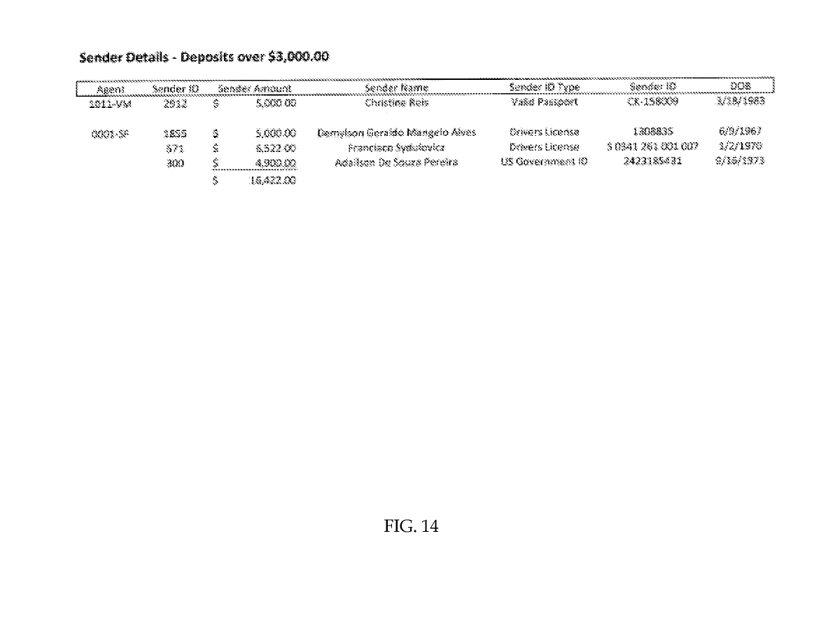

Often financial institution 28 (FIG. 5) may need information about individual transactions that exceed $3,000.00. Accordingly, an operator at financial institution 28 can execute another filtering query at the database of storage device 72 requesting such information. The results of such a query is shown in FIG. 14 for transactions attributable to remitter 20 on a specific date. These query results do not include transactions exceeding $10,000.00 since those are normally queried separately and require different handling. Basically, the information listed in FIG. 14 is a subset of the information provided in FIGS. 12 and 13. The operator may be given an opportunity to expand the information of FIG. 14 to provide all of the data provided in FIGS. 12 and 13.

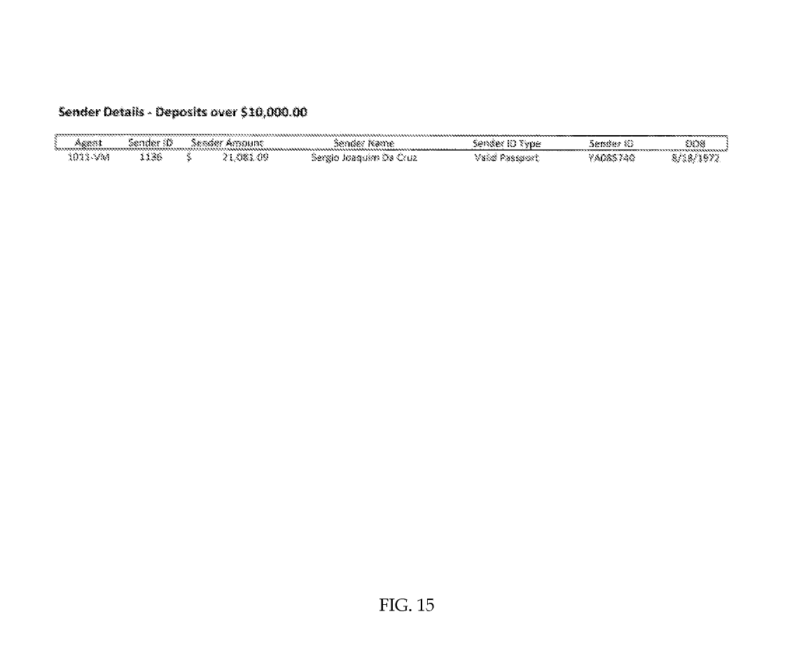

Often financial institution 28 (FIG. 5) may need information about individual transactions that exceed $10,000.00. Accordingly, an operator at financial institution 28 can execute another filtering query at the database of storage device 72 requesting such information. The results of such a query are shown in FIG. 15 for transactions attributable to remitter 20 on a specific date. As before, the information listed in FIG. 15 is a subset of the information provided in FIGS. 12 and 13, which can be expanded to provide all available data.

It is appreciated that various modifications may be implemented with respect to the above described embodiments. The foregoing steps may be executed in different orders and in some embodiments the system may eliminate some of the steps or include additional steps. Furthermore, the information displayed in FIGS. 9-15 can be altered to include a different amount of information and also provide optional links for executing different procedures or for gathering a variety of information. Also, the illustrated databases can contain information of any type desired by users of this system. The amount of information stored in a database can be more or less than that described above. Some of the steps described for the foregoing system may be paperless and executed electronically, but in some cases individual steps may be performed manually and with paper and pen. The form of the deposit slip can be varied depending upon the amount of information desired on the slip and the requirements of the financial institution accepting the deposit.

Obviously, many modifications and variations of the present invention are possible in light of the above teachings. It is therefore to be understood that within the scope of the appended claims, embodiments of the present invention may be practiced otherwise than as specifically described.

While the foregoing is directed to embodiments of the present disclosure, other and further embodiments of the disclosure may be devised without departing from the basic scope thereof. It is also understood that various embodiments described herein may be utilized in combination with any other embodiment described, without departing from the scope contained herein. In addition, embodiments of the present disclosure are further scalable to allow for additional clients and servers, as particular applications may require.

What is claimed is:

1. A computer implemented method for facilitating a bulk deposit to a financial institution, the method comprising:
at a computer having one or more processors and memory storing one or more programs for execution by the one or more processors:
receiving and storing transaction information concerning one or more transactions between an agent and one or more customers of the agent;
generating a deposit slip adapted for delivery to the financial institution, the deposit slip comprising identifiers associated with one or more customers of the agent and bulk cash corresponding to the transaction information; and
transmitting a predetermined portion of the transaction information to the financial institution, the predetermined portion comprising a correlation to the deposit slip and detail greater than that produced on the deposit slip.

2. The method of claim 1 wherein the deposit slip lists one or more customers of the agent without listing an additional agent's customers.

3. The method of claim 1 wherein transaction information comprises at least one of a customer name, a customer address, a beneficiary name, and a beneficiary address.

4. The method of claim 1 wherein the transaction information comprises at least one of data associated with a form of identification, an identification number, a telephone number, and bank information.

5. The method of claim 1 wherein the transaction comprises at least one of a customer date of birth and a type of customer identification presented.

6. The method of claim 1 further comprising:
filtering and displaying transaction data based on one or more of a date, an agent identification, a customer identification, a minimum monetary amount, a street, a municipality, a state, a province, a postal code, a telephone number, an identification number, a first name, and a last name.

7. The method of claim 1 wherein further comprising:
filtering and displaying transaction data based on one or more of a date, an agent identification, a minimum monetary amount, a customer street, a customer town, a customer state, a customer province, a customer postal code, a customer telephone number, a customer identification number, a customer first name, a customer last name, a receiver street, a receiver state, a receiver province, a receiver postal code, a receiver telephone number, a receiver identification number, a receiver first name, and a receiver last name.

8. The method of claim 1 wherein the deposit slip comprises a listing of transaction amounts for each of the one or more customers of the agent, an amount of bulk cash being delivered to the financial institution with the deposit slip, and a summary of any discrepancy between the listing of transaction amount and bulk cash being delivered to the financial institution.

9. The method of claim 8 wherein the deposit slip is produced to the financial institution upon approval by an administrator.

10. The method of claim 9, wherein approval by an administrator comprises:
displaying to the administrator at least a portion of the transaction information, thereby allowing the administrator to consider in advance whether the summary of any discrepancy evidences either misappropriation by delivery of inadequate bulk cash, or money laundering by delivery of excess currency.

11. The method of claim 1, further comprising:
transmitting a request for the agent to provide specified information about an identification supplied by one or more customers.

12. The method of claim 11 wherein the specified information comprises an image of the identification.

13. The method of claim 1, wherein the bulk deposit is placed on hold until a currency transaction report is completed online if one or more transactions exceed a total predetermined monetary amount.

14. A computer implemented method for accepting bulk cash at a financial institution based on transaction information stored by a provider concerning one or more transactions between an agent of a remitter and one or more customers of the agent, the method comprising:
at a computer having one or more processors and memory storing one or more programs for execution by the one or more processors:
receiving a deposit slip having a marking signifying the one or more customers, together with bulk cash corresponding to the transaction information;
receiving at least a portion of the transaction information, the at least a portion of the transaction information comprising a correlation to the deposit slip, and detail greater than that produced on the deposit slip;
analyzing the at least a portion of the transaction information and determining if a predetermined condition is met;
transmitting a request for further information if the predetermined condition is met; and
approving and receiving the bulk case if the further information is received.

15. The method of claim 14 wherein analyzing the at least a portion of the transaction information comprises examining whether the one or more transactions exceed a total predetermined monetary amount.

16. The method of claim 14 wherein analyzing the further information comprises one or more of a customer date of birth and type of customer identification presented.

17. A computer implemented method for facilitating a bulk deposit to a financial institution, the method comprising:
at a computer having one or more processors and memory storing one or more programs for execution by the one or more processors:
receiving and storing transaction information concerning one or more transactions between an agent and one or more customers of the agent;
generating a deposit slip adapted for delivery to the financial institution, the deposit slip comprising identifiers associated with one or more customers of the agent and bulk cash corresponding to the transaction information, the deposit slip further comprising a listing of transaction amounts for each of the one or more customers of the agent, an amount of bulk cash being delivered to the financial institution with the deposit slip, and a summary of any discrepancy between the listing of transaction amount and bulk cash being delivered to the financial institution; and
transmitting a predetermined portion of the transaction information to the financial institution, the predetermined portion comprising a correlation to the deposit slip and detail greater than that produced on the deposit slip

18. The method of claim 17 wherein transaction information comprises at least one of a customer name, a customer address, a beneficiary name, and a beneficiary address.

19. The method of claim 17, wherein the bulk deposit is placed on hold until a currency transaction report is completed online if one or more transactions exceed a total predetermined monetary amount.

20. The method of claim 17 further comprising:
filtering and displaying transaction data based on one or more of a date, an agent identification, a minimum monetary amount, a customer street, a customer town, a customer state, a customer province, a customer postal code, a customer telephone number, a customer identification number, a customer first name, a customer last name, a receiver street, a receiver state, a receiver province, a receiver postal code, a receiver telephone number, a receiver identification number, a receiver first name, and a receiver last name.
